(19) United States
(12) Patent Application Publication
(10) Pub. No.: US 2025/0045699 A1
(43) Pub. Date: Feb. 6, 2025

(54) INFORMATION PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Le GUO, Beijing (CN); Ming LV, Beijing (CN); Xiaotong ZHAO, Beijing (CN)

(21) Appl. No.: 18/710,154

(22) PCT Filed: Nov. 15, 2022
(86) PCT No.: PCT/CN2022/131908

§ 371 Date: May 14, 2024

(30) Foreign Application Priority Data
Nov. 15, 2021 (CN) 202111350473.0

(51) Int. Cl. G06Q 10/105; G06F 3/0486

(52) U.S. Cl. CPC G06Q 10/105; G06F 3/0486

(57) ABSTRACT

An information processing method and apparatus, an electronic device, and a storage medium. The information processing method provided by the present disclosure includes: displaying an adjustment interface of an organizational structure on a display interface in response to a first operation event, a pattern of an organization department in the organizational structure being displayed in the adjustment interface, and the pattern being displayed according to a hierarchical relationship of the organization department; in response to a second operation event based on the pattern, generating a first processing item for adjusting the organizational structure; and triggering a processing flow of the first processing item in response to a third operation event.

### CROSS-REFERENCE TO RELATED APPLICATION(S)

This application is based on Chinese patent application No. 202111350473.0, filed on Nov. 15, 2021 and entitled “INFORMATION PROCESSING METHOD AND APPARATUS, ELECTRONIC DEVICE, AND STORAGE MEDIUM”, and claims the priority of the Chinese patent application, the present disclosure of which is incorporated herein by reference.

### TECHNICAL FIELD

The present disclosure relates to the technical field of computers, in particular to an information processing method and apparatus, an electronic device and a storage medium.

### BACKGROUND

Organizational structure, including the superior-subordinate relationship between departments and the personnel in the departments, sometimes needs to be adjusted within an enterprise to change the superior-subordinate relationship of the organizational structure, the departments in the organizational structure and the personnel in the departments.

### SUMMARY

The present disclosure provides an information processing method, an information processing apparatus, an electronic device and a storage medium.

The present disclosure adopts the following technical solution.

In some embodiments, the present disclosure provides an information processing method, including:
in response to a first operation event, displaying an adjustment interface of an organizational structure on a display interface, a pattern of an organization department in the organizational structure being displayed in the adjustment interface, and the pattern being displayed according to a hierarchical relationship of the organization department;
in response to a second operation event based on the pattern, generating a first processing item for adjusting the organizational structure; and
in response to a third operation event, triggering a processing flow of the first processing item.

In some embodiments, the present disclosure provides an information processing apparatus, including:
a display unit, configured to display an adjustment interface of an organizational structure on a display interface in response to a first operation event, wherein a pattern of an organization department in the organizational structure is displayed in the adjustment interface, and the pattern is displayed according to a hierarchical relationship of the organization department;
a control unit, configured to generate a first processing item for adjusting the organizational structure in response to a second operation event; and
a processing unit, configured to trigger a processing flow of the first processing item in response to a third operation event.

In some embodiments, the present disclosure provides an electronic device including at least one memory and at least one processor;
wherein the at least one memory is configured to store program codes, and the at least one processor is configured to invoke the program codes stored in the at least one memory to execute the above-described method.

In some embodiments, the present disclosure provides a computer-readable storage medium for storing program codes, wherein when executed by a processor, the program codes cause the processor to perform the above-described method.

The present disclosure provides an information processing method, including: in response to a first operation event, displaying an adjustment interface of an organizational structure on a display interface, a pattern of an organization department in the organizational structure being displayed in the adjustment interface, and the pattern being displayed according to a hierarchical relationship of the organization department; in response to a second operation event based on the pattern, generating a first processing item for adjusting the organizational structure; and in response to a third operation event, triggering a processing flow of the first processing item. The embodiments of the present disclosure can facilitate the adjustment of the organizational structure.

### BRIEF DESCRIPTION OF PATTERNS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are schematic, and components and elements are not necessarily drawn to scale.

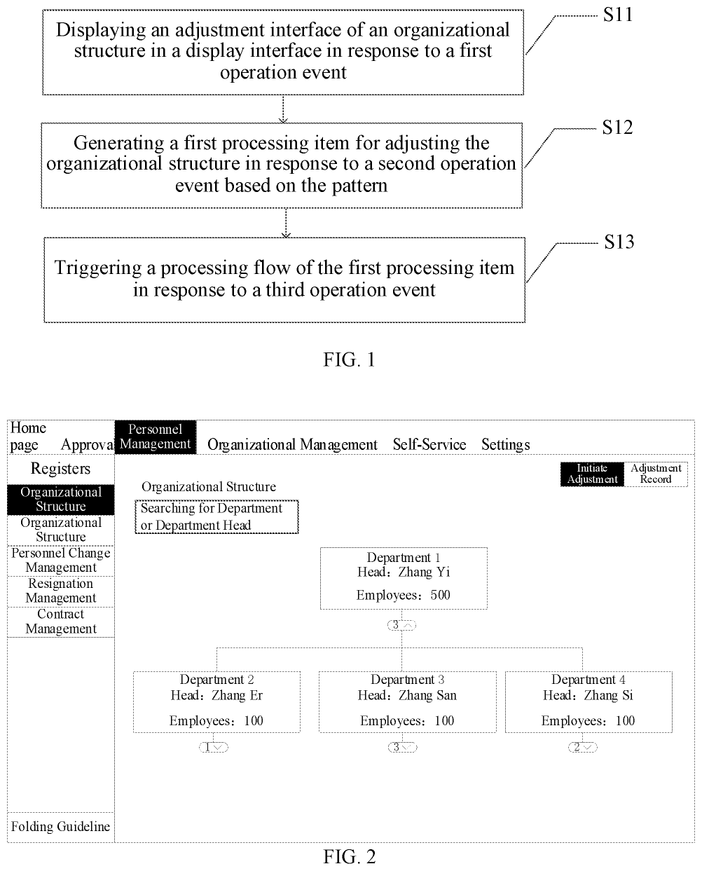

FIG. 1 is a flowchart of an information processing method according to an embodiment of the present disclosure.

FIG. 2 is a schematic diagram of an adjustment interface according to an embodiment of the present disclosure.

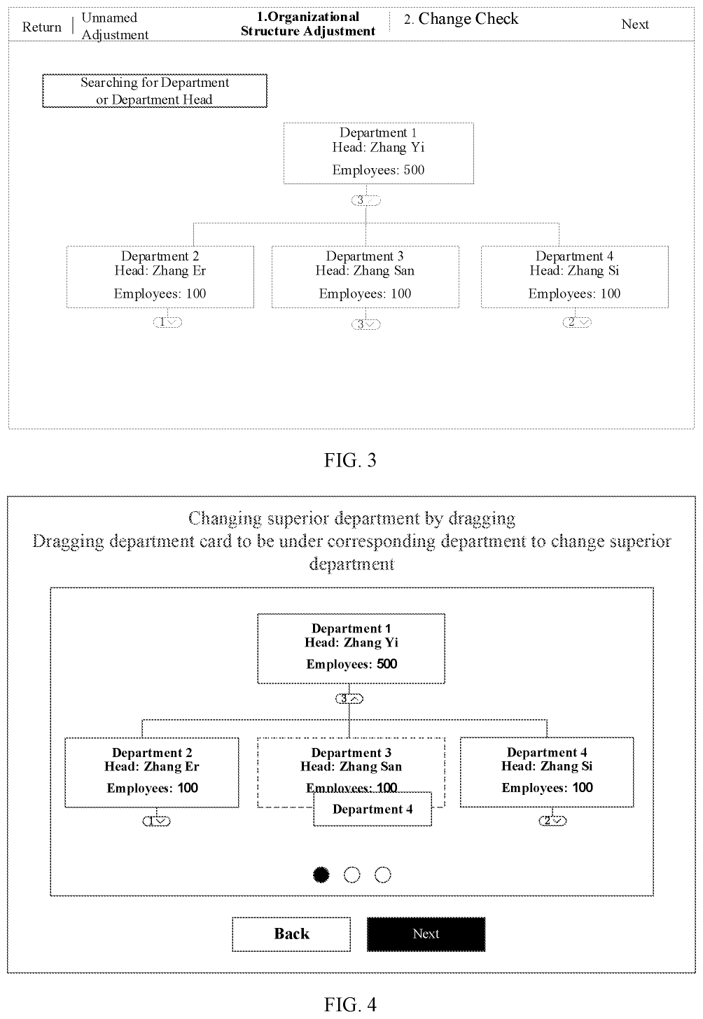

FIG. 3 is a schematic diagram of an adjustment interface according to an embodiment of the present disclosure.

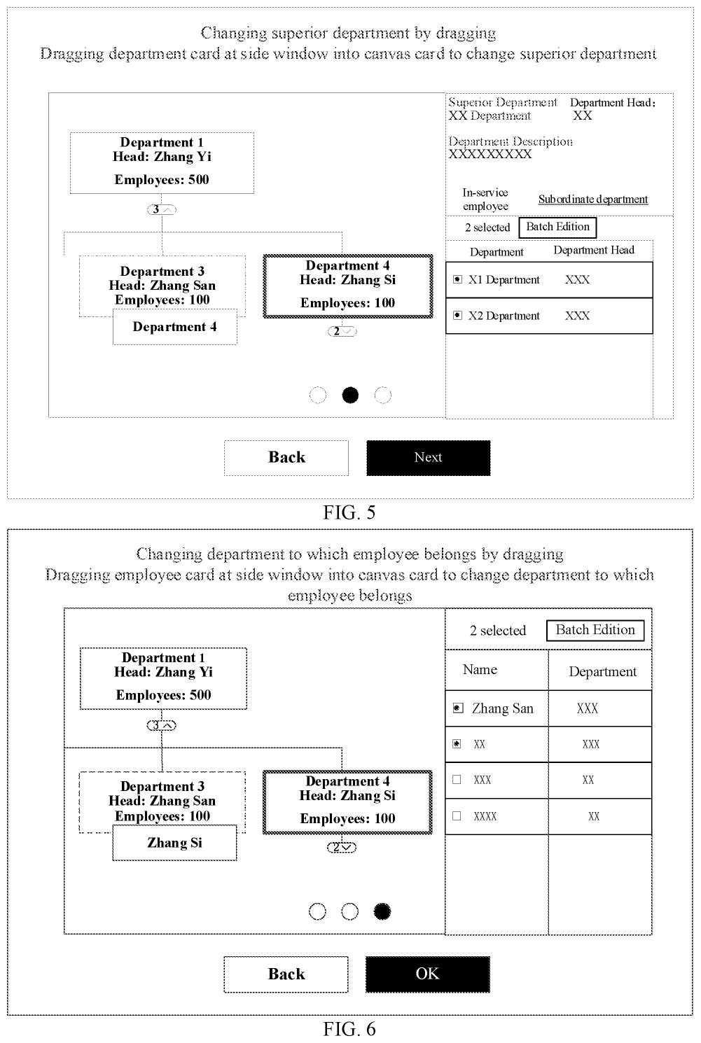

FIGS. 4 to 6 are schematic diagrams showing effects of a guidance interface according to an embodiment of the present disclosure.

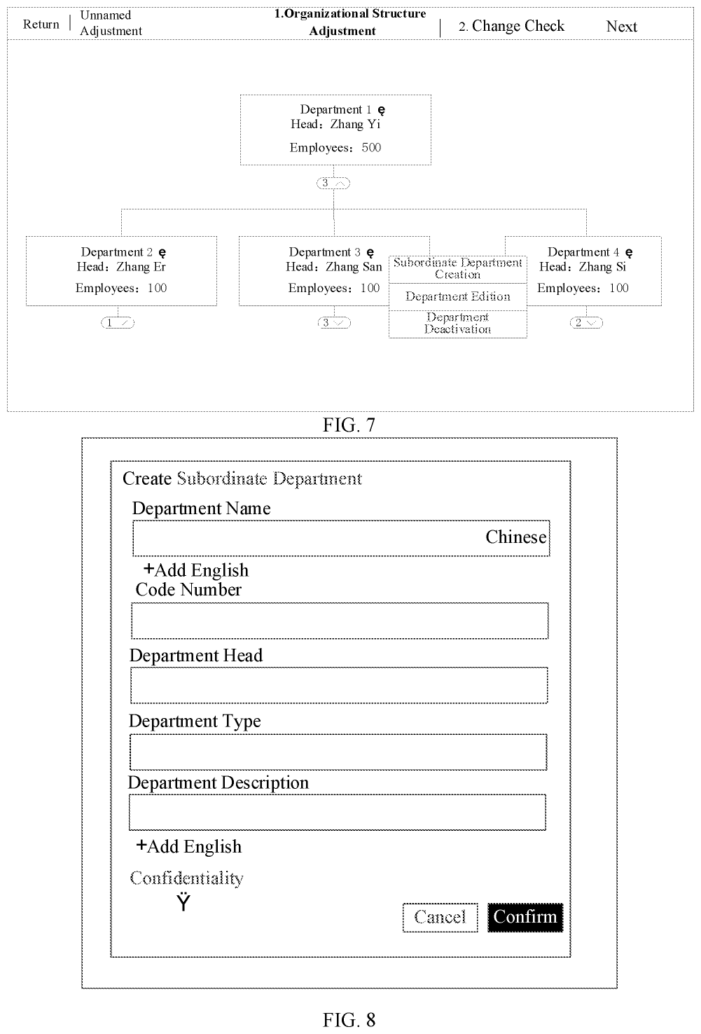

FIG. 7 is a schematic diagram of an adjustment interface according to an embodiment of the present disclosure.

FIG. 8 is a schematic diagram of an interface of a newly-created subordinate department in an embodiment of the present disclosure.

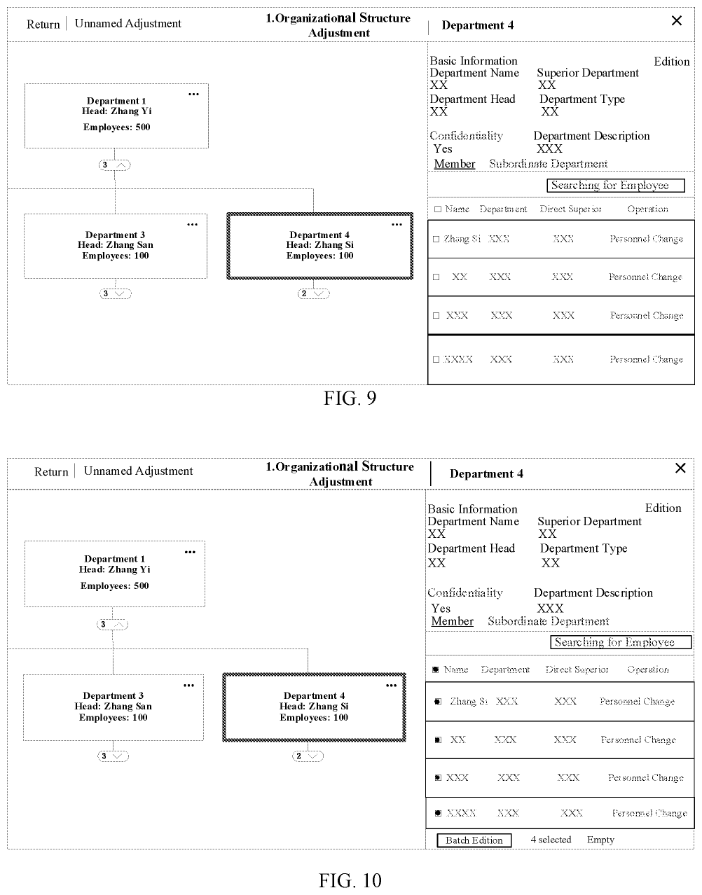

FIG. 9 is a schematic diagram of an adjustment interface and an information interface according to an embodiment of the present disclosure.

FIG. 10 is a schematic diagram of an adjustment interface and an information interface according to an embodiment of the present disclosure.

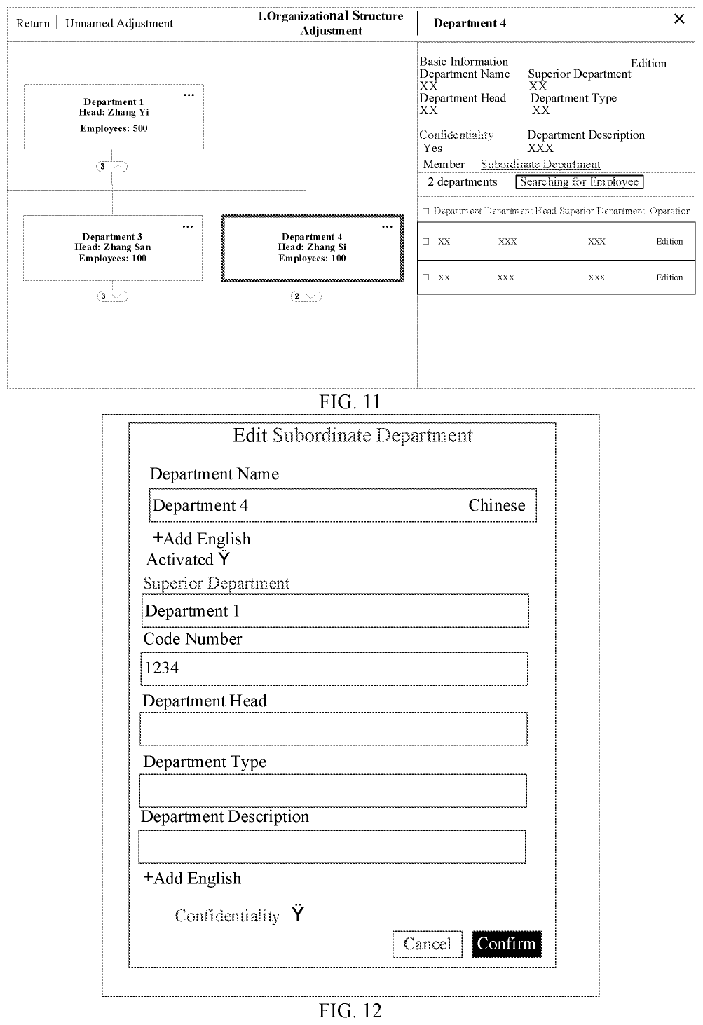

FIG. 11 is a schematic diagram of an adjustment interface and an information interface according to an embodiment of the present disclosure.

FIG. 12 is a schematic diagram of an edition interface according to an embodiment of the present disclosure.

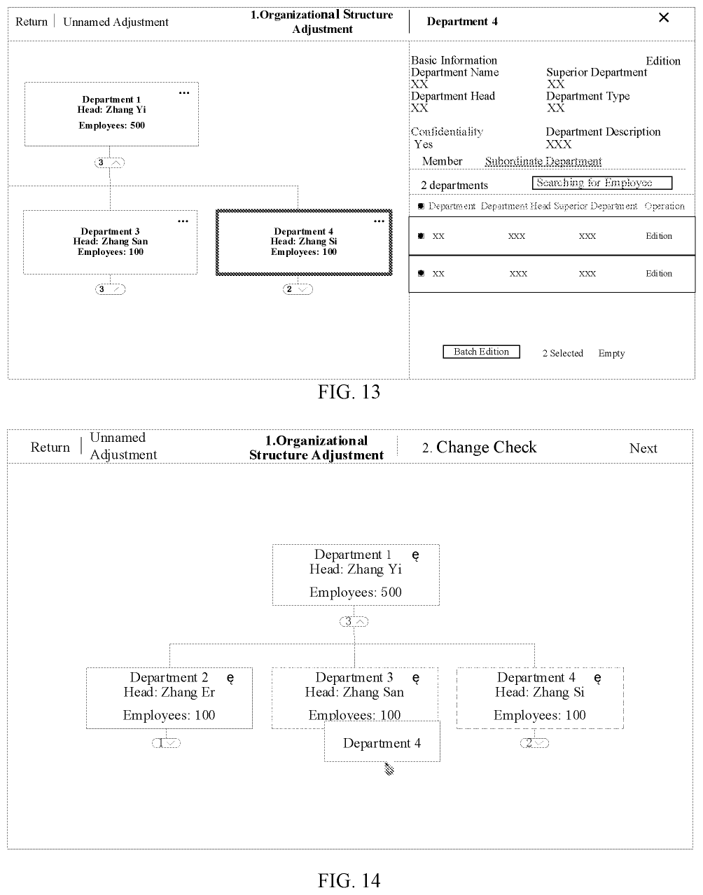

FIG. 13 is a schematic diagram of an adjustment interface and an information interface according to an embodiment of the present disclosure.

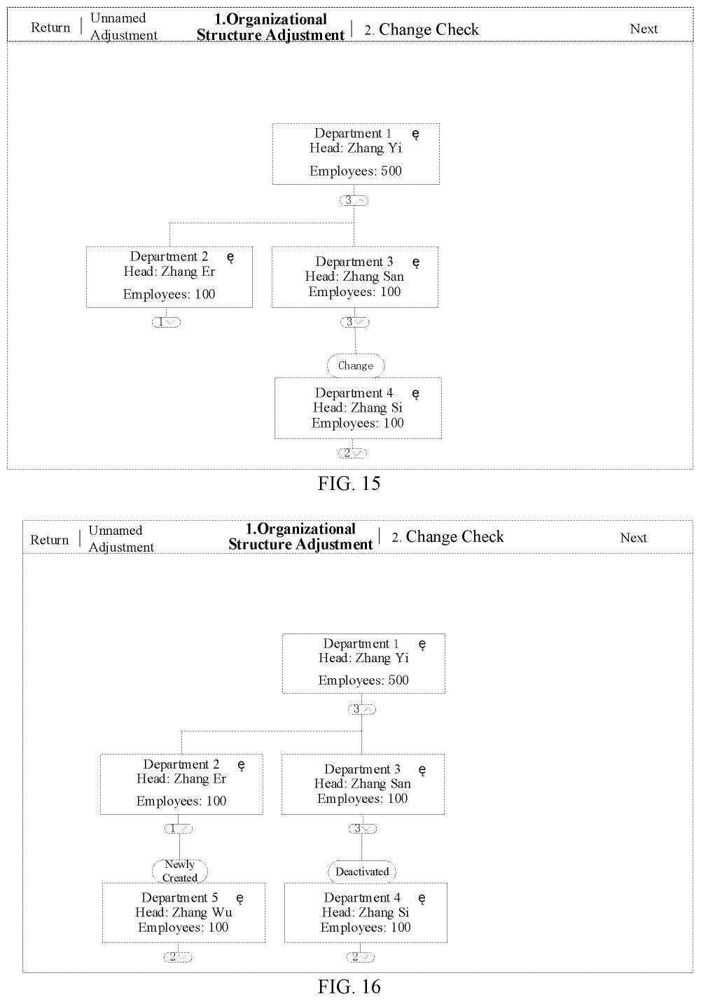

FIGS. 14 to 15 are schematic diagrams of an embodiment of the present disclosure in which an organizational structure is adjusted by dragging a pattern.

FIG. 16 is a schematic diagram of an organizational structure according to an embodiment of the present disclosure.

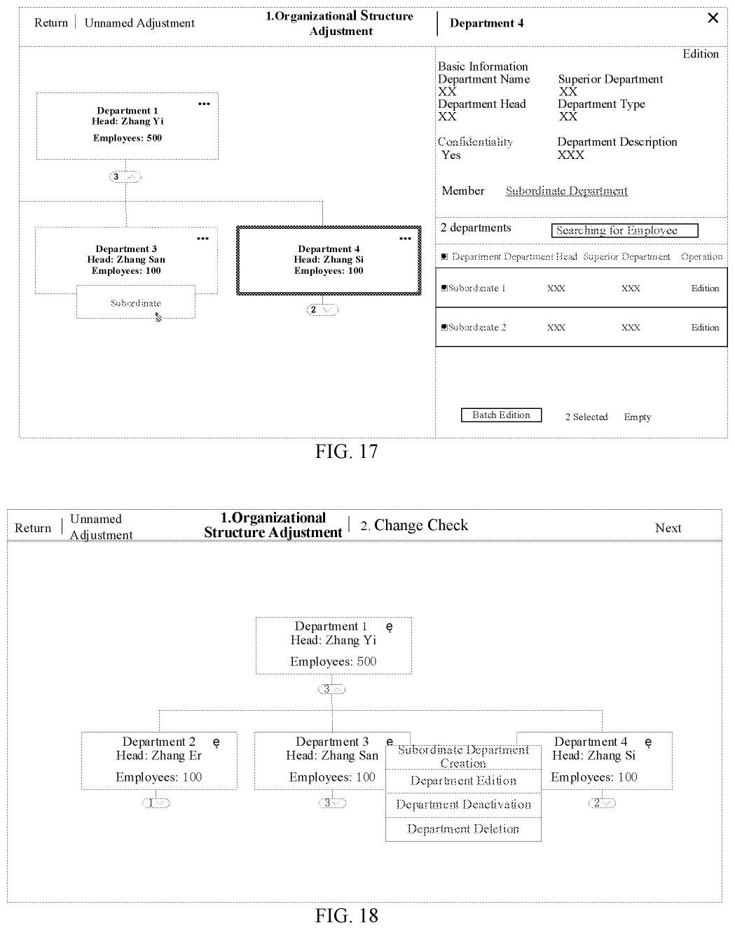

FIG. 17 is a schematic diagram of an embodiment of the present disclosure in which an organizational structure is adjusted by dragging a subordinate department.

FIG. 18 is a schematic diagram of a pattern-associated control of an organizational architecture according to an embodiment of the present disclosure.

FIG. 19 is a schematic diagram of saving a personnel change in an embodiment of the present disclosure.

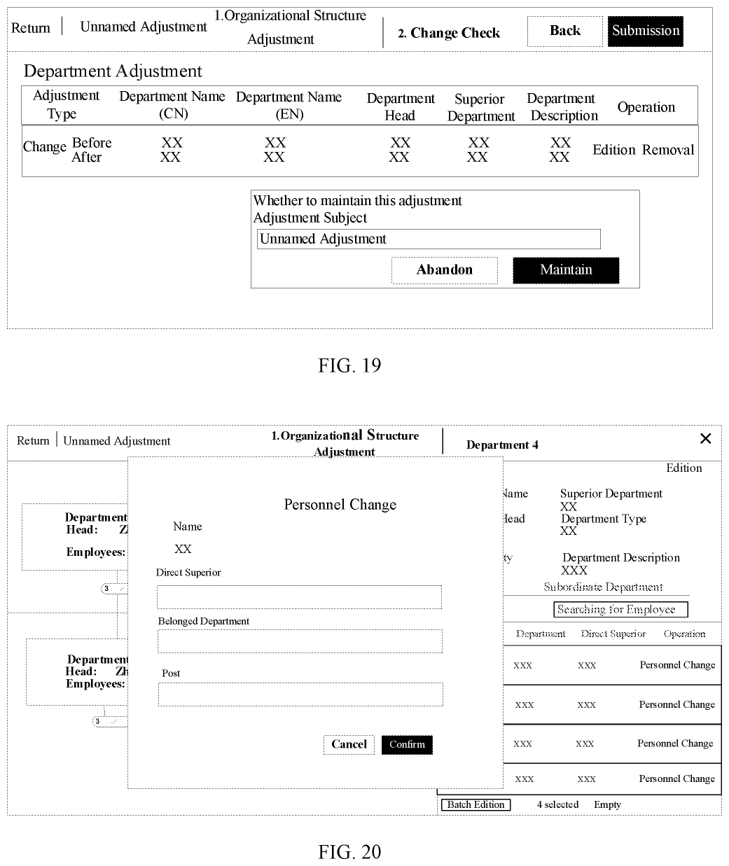

FIG. 20 is a schematic diagram of displaying a personnel change processing according to an embodiment of the present disclosure.

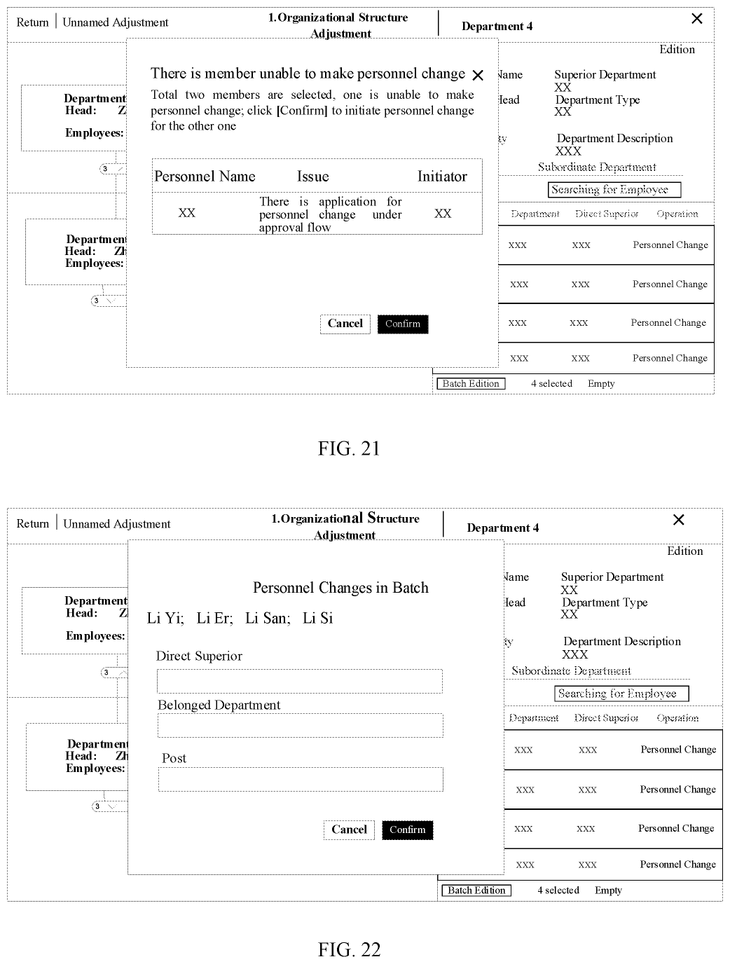

FIG. 21 is a schematic diagram of a prompt during personnel change processing according to an embodiment of the present disclosure.

FIG. 22 is a schematic diagram of displaying personnel change processing in batch according to an embodiment of the present disclosure.

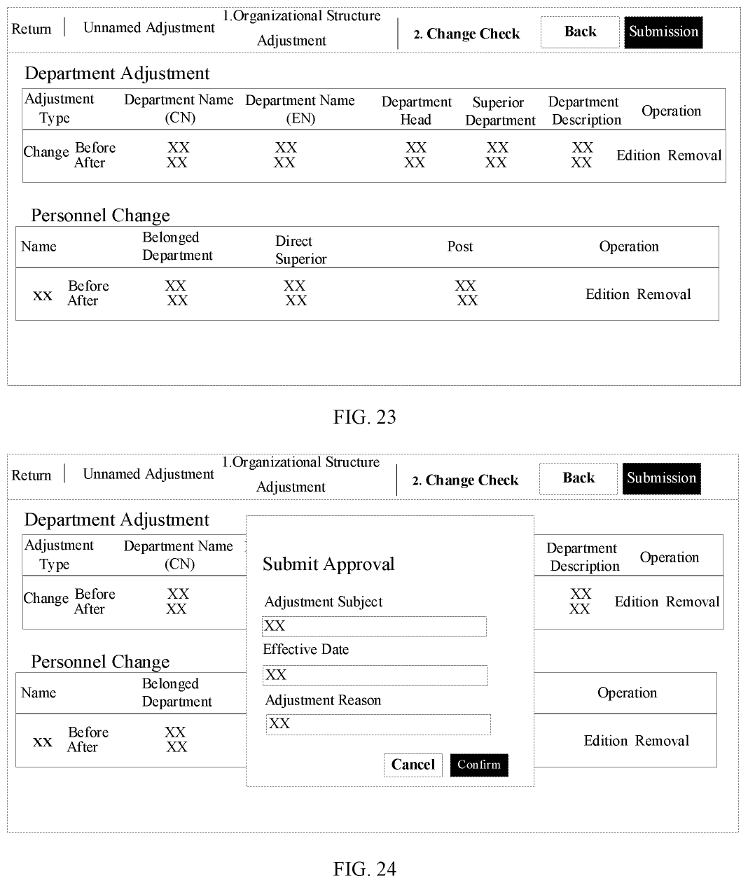

FIG. 23 is a schematic diagram of displaying an adjustment content according to an embodiment of the present disclosure.

FIG. 24 is a schematic diagram of displaying a submission interface according to an embodiment of the present disclosure.

FIG. 25 is a schematic diagram of displaying a conflict information interface according to an embodiment of the present disclosure.

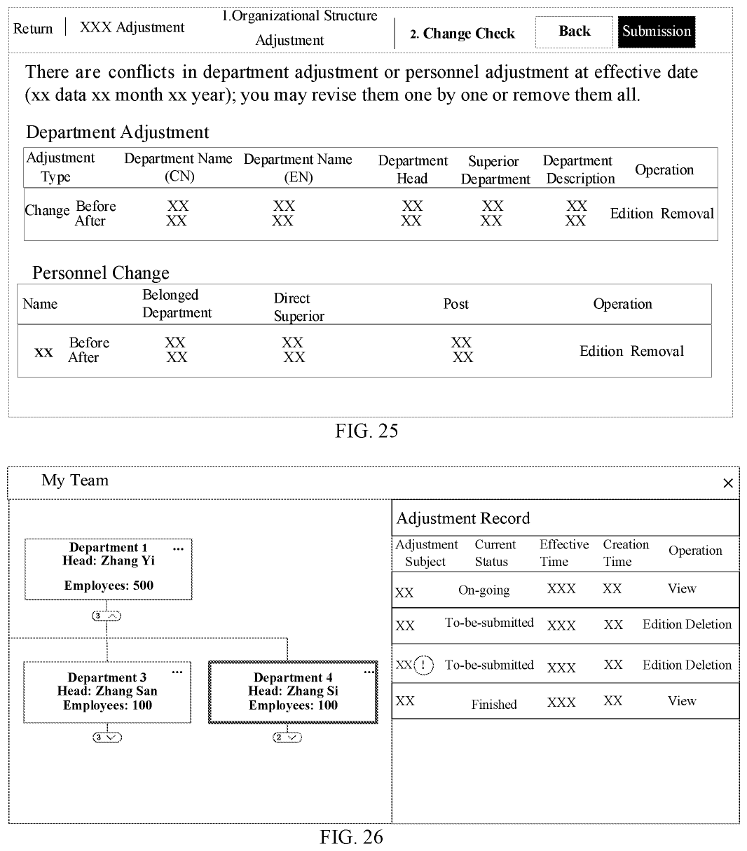

FIG. 26 is a schematic diagram of displaying a processing item interface according to an embodiment of the present disclosure.

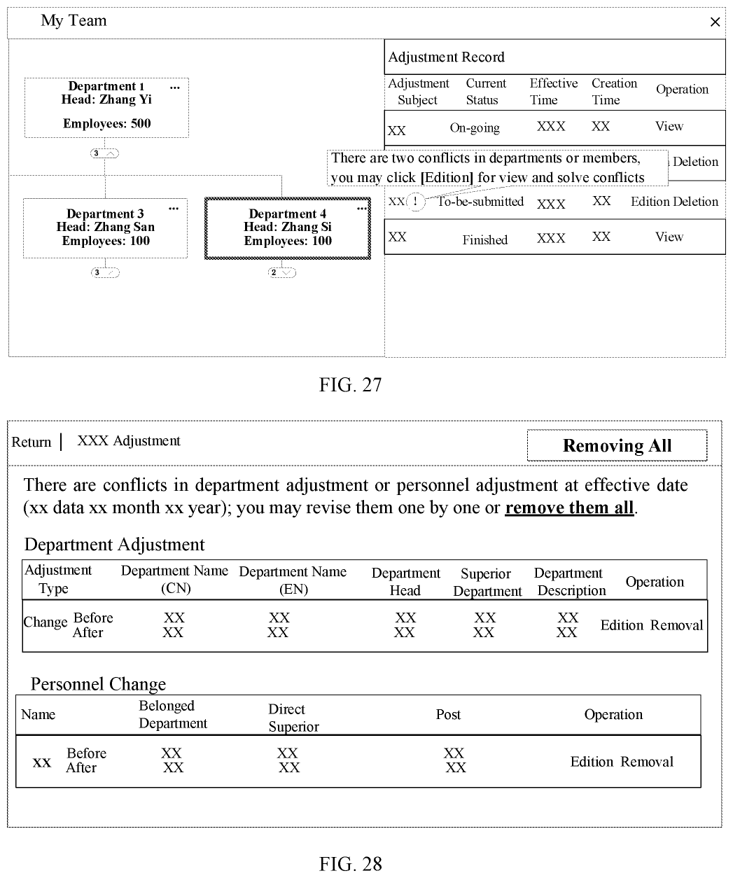

FIG. 27 is a schematic diagram of displaying a processing item interface according to an embodiment of the present disclosure.

FIG. 28 is a schematic diagram of displaying a conflict information interface according to an embodiment of the present disclosure.

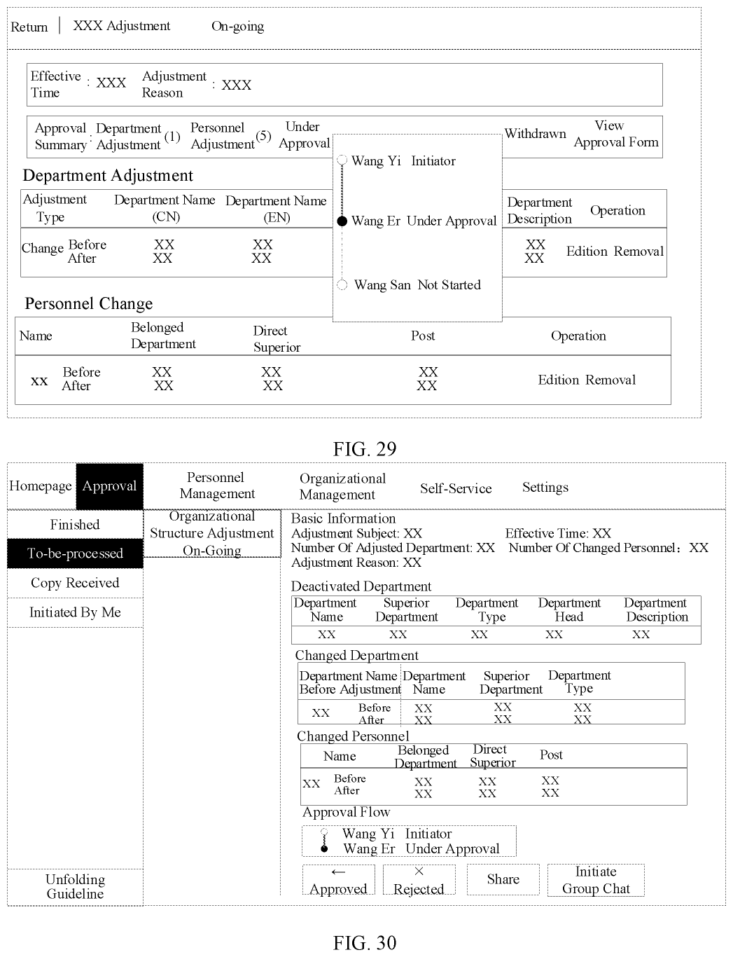

FIG. 29 is a schematic diagram of displaying a processing item status interface according to an embodiment of the present disclosure.

FIG. 30 is a schematic diagram of displaying a processing flow according to an embodiment of the present disclosure.

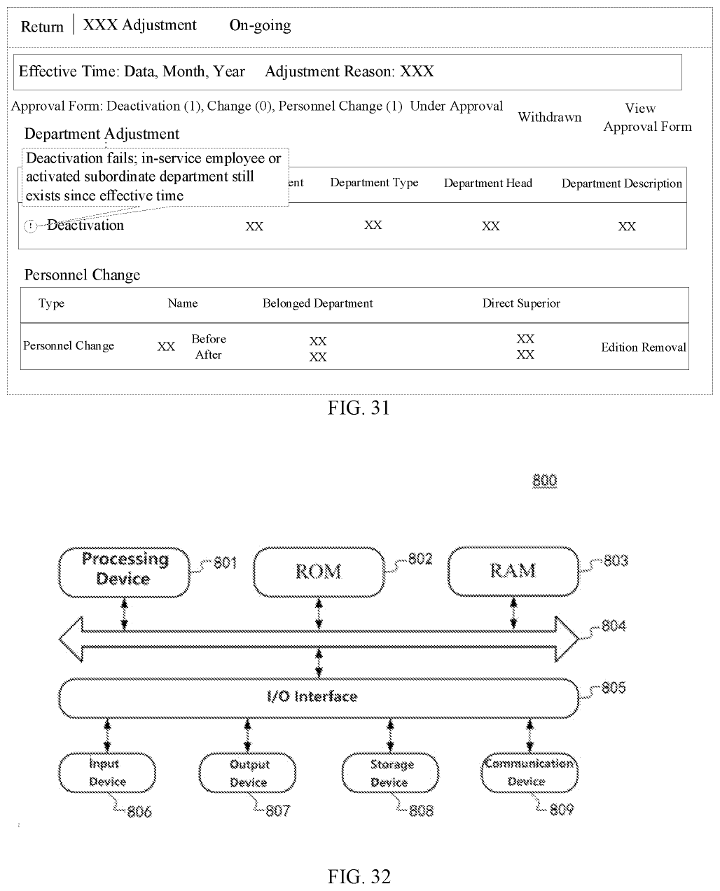

FIG. 31 is a schematic diagram of displaying a processing item status interface according to an embodiment of the present disclosure.

FIG. 32 is a schematic structural diagram of an electronic device according to an embodiment of the present disclosure.

### DETAILED DESCRIPTION

Embodiments of the present disclosure will be described in more details below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the scope of protection of the present disclosure.

It should be understood that various steps described in the method embodiments of the present disclosure can be performed in parallel. Furthermore, method embodiments may include additional steps and/or omit performing the illustrated steps. The scope of the present disclosure is not limited in this respect.

As used herein, the term “including/comprising” and its variants are open-ended, that is, “including/comprising but not limited to”. The term “based on” is “at least partially based on”. The term “one embodiment” refers to “at least one embodiment”; the term “another embodiment” refers to “at least one other embodiment”; the term “some embodiments” refers to “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifying word such as “a/an” mentioned in the present disclosure is schematic rather than limiting, and those skilled in the art should understand that it should be interpreted as “one or more” unless the context clearly indicates otherwise.

Names of messages or information exchanged among multiple devices in the embodiments of the present disclosure are only used for illustrative purposes, and are not used to limit the scope of these messages or information.

Hereinafter, the technical solution provided by the embodiment of the present disclosure will be described in details with reference to the accompanying drawings.

Within an enterprise, it is desirable to conveniently perform operations to an organizational structure such as adding, editing and deactivating organization departments during an adjustment of the organizational structure, in which the departments to which the department members belong, the direct superiors of the department members, and staffs of the department members can be modified. It is also expected to approve and track the adjustment after the adjustment is completed, and to search and view all the changed items in the adjustment of the organizational structure.

As shown in FIG. 1, which is a flowchart of an information processing method according to an embodiment of the present disclosure, including the following steps.

S11: In response to a first operation event, displaying an adjustment interface of an organizational structure on a display interface.

In some embodiments, the first operation event may include one or more operations, and the adjustment interface displays the patterns of the organization departments in the organizational structure, which can be, for example, cards of the organization departments or icons of the organization departments. The patterns are displayed according to the hierarchical relationships of the organization departments, and the patterns of the organization departments can be displayed in a tree structure diagram. The adjustment interface can be the interface displayed after a specific control is triggered.

S12: In response to a second operation event based on the pattern, generating a first processing item for adjusting the organizational structure.

In some embodiments, the organizational structure is adjusted based on the patterns, so that the association relationship of the organizational structure and the association relationship after adjustment can be intuitively reflected, which allows the adjustment of the organizational structure to be clearer and to have more intuitive results. The first processing item is an adjustment content of the organizational structure in this adjustment, including the adjustment of organization departments and the adjustment of department members. The adjustment of department members can also be expressed as the change of department members. The adjustment of organization departments can include the change of the hierarchical relationship (superior-subordinate relationship) of organization departments, and the deactivation, activation or the like of organization departments.

S13: In response to a third operation event, triggering a processing flow of the first processing item.

In some embodiments, the processing flow of the first processing item may include one or more nodes, and different nodes correspond to different processing personnel. The third operation event can be composed of one or more operations.

The embodiment of the present disclosure will be further explained in conjunction with the accompanying drawings. As shown in FIG. 2, the first operation event may include processing the “Personnel Management” control firstly, then triggering the “Organizational Structure” control, and then clicking “Initiating Adjustment”. At this time, a tree structure diagram of the organizational structure is displayed in the adjustment interface. The tree structure diagram is generated according to the hierarchical relationship of the organizational structure. The patterns in FIG. 2 are cards, and each card corresponds to one organization department. The pattern can display the information of the corresponding organization department, such as name, head, number of employees, etc. If the organization department has subordinate departments, the number of subordinate departments will be displayed in the associated area of the pattern, and controls can be displayed in the associated area to expand or hide the subordinate departments. By operating the pattern of the organization department, the first processing item is generated. The first processing item records the adjustment of the organization department and the adjustment of the department members, but the first processing item is not implemented immediately, but needs to be approved. Therefore, the third operation event needs to be executed to trigger the processing flow of the first processing item, such as the approval flow. After the processing flow is completed, it is determined whether to execute the first processing item according to the processing result, that is, whether to adjust the organizational structure according to the first processing item.

In some embodiments, the organization department has different statuses, including deactivated status, activated status, etc. Only the patterns of the organization departments currently in activated status are displayed in the adjustment interface, and an activated status indicates that the organization department is operating normally and there is no deactivation processing flow or plan. The current user can adjust the hierarchical relationship or members of the organization departments based on the patterns displayed in the organization adjustment interface. Thus, it is necessary to ensure that the current user has the authority of adjustment, and the adjustment interface only displays the organization departments within the current user's scope of authority. In some embodiments, as shown in FIG. 3, the patterns in the display interface are displayed in the form of a tree structure diagram according to the hierarchical relationship of the organization departments. This can clearly show the superior-subordinate relationship of the organization departments. In some embodiments, information such as the name of the corresponding organization department, the head, the number of department members, etc. is displayed in the pattern. In some embodiments, there is a search control in the adjustment interface, which is configured to search according to the organization department or the head. In this embodiment, the search for the organization department or the head is supported, and the search scope includes the organization department added or changed in the first processing item.

In some embodiments of the present disclosure, when a user opens an adjustment page of the organizational structure for the first time, a guidance interface is displayed. The guidance interface is configured to show the operation mode of the adjustment page of the organizational structure. In some embodiments, when the user enters the adjustment interface of the organizational structure for the first time, it is necessary to display the guidance interface to inform the user how to operate. For the same user, the guidance interface is displayed only once, as shown in FIGS. 4 to 6. The guidance interface can be composed of one or more interfaces. In the guidance interface, how to adjust the superior department to which the organization department belongs and how to change the organization department to which the department members (employees) of the organization department belong can be displayed.

In some embodiments of the present disclosure, in response to the second operation event based on the pattern, the first processing item for adjusting the organizational structure is generated, including: in response to a trigger operation on a first control of a first pattern, creating a subordinate department of the organization department corresponding to the first pattern and displaying the pattern of the created subordinate department. In some embodiments, as shown in FIG. 7, an option control is displayed in the pattern (in the form of a card), which is shown as “ . . . ” at the upper right of the pattern in FIG. 7. After the option control is triggered, as shown in FIG. 7, a plurality of options is displayed, in which the control “create a new subordinate department” is just the first control, and a subordinate department can be created under the organization department corresponding to the pattern by triggering the first control.

In some embodiments of the present disclosure, if the organization department corresponding to the first pattern satisfies a first preset condition, the first control is displayed; otherwise, the first control is not displayed or cannot be triggered. In some embodiments, the first preset condition includes at least one of the following: the organization department is in an activated status, the organization department has no deactivated version in future, and the organization department is not in a deactivation processing flow. In some embodiments, it is necessary to satisfy all of the above three conditions at the same time to display the available first control. If the organization department corresponding to the first pattern is not currently in an activated status, the first control is hidden. An activated status is different from a deactivated status, indicating that the organization department is operating normally. If the organization department corresponding to the first pattern has a deactivated version in future, that is, the organization department corresponding to the first pattern will be deactivated in future, the first control can be grayed out and cannot be triggered, and a prompt information can be displayed when a control indicator hovers over the first control, e.g., this department has been deactivated on {effective date of deactivated version}, and no subordinate department can be created. When the organization department corresponding to the first pattern is in a deactivation processing flow, it indicates that it is currently being applied for deactivation. At this time, the first control cannot be triggered, and the first control can be grayed out. When the control indicator hovers over the first control, a prompt information can be displayed, e.g., this department is in a deactivation processing flow by an initiator “a name link for the initiator”, please complete this flow before creating a new department. That is, the prompt information can display a link to contact the initiator of the deactivation processing flow, and the initiator can be contacted by triggering the link.

In some embodiments of the present disclosure, as shown in FIG. 8, after the first control is triggered, an interface for creating a new subordinate department is displayed, in which the name, head, type and description of the organization department, and the option of whether the organization department is confidential are displayed. After inputting the corresponding contents, the newly created subordinate department is confirmed. In some embodiments, the patterns of newly-created subordinate departments are displayed at the rightmost side of the lower layer of the patterns of their superior departments, and are marked, which is configured to identify the departments as newly-created organization departments.

In some embodiments of the present disclosure, if a pattern is triggered, the information interface of the organization department corresponding to the triggered pattern is displayed. The information interface displays the information of the organization department corresponding to the pattern. In some embodiments, as shown in FIG. 9, the pattern can be triggered by clicking the area in the pattern except the option control “. . . ” (for example, clicking the pattern of department 4 in FIG. 9). At this time, the information interface of the popped-out department can be displayed at one side of the adjustment interface, for example, at the right side (refer to the right part of FIG. 9), so that the specific content of the organization department can be viewed through the pattern for reference when adjusting the organizational structure.

In some embodiments of the present disclosure, at least one of the following items is displayed in the information interface: basic information of the organization department, department members of the organization department, and subordinate departments of the organization department. In some embodiments, as shown in FIG. 9, the basic information of the organization department includes one or more of the department name, superior department, department head, department type, whether it is a confidential department or not, and descriptive information about the organization department. The department members of an organization department and the employees belonging to the organization department do not include the department members of the indirect subordinate departments. The subordinate departments include the direct subordinate departments of the organization department, and may also include the indirect subordinate departments. Organization members and subordinate departments can be located in two sub-interfaces in the information interface. The two sub-interfaces have corresponding identifiers (members and subordinate departments shown in FIG. 9) respectively, and the corresponding sub-interfaces are displayed by triggering the corresponding identifiers. The displayed information of the department member can include name, staff number, email address, direct superior, sequence, grade, work place, employment date, etc.; the displayed information can be customized so that only one or several of them can be displayed; and the displayed information can be sorted by names. As shown in FIG. 9, a search control is displayed and configured to search for department members according to one or several conditions of name, direct superior, sequence, grade, work place or personnel type of the employee. The subordinate departments displayed in the information interface are the direct subordinate departments in an activated status, excluding the indirect subordinate departments and the subordinate departments added, deactivated and changed to the organization department in the first processing item. In the information interface, one or more of name, code number, department head, superior department, description, status, department type and confidentiality can be displayed, and one or more of them can be customized. When there is a subordinate department that is added, changed or deactivated in the first processing item, an associated identifier is displayed, which is configured to indicate that the subordinate department is the subordinate department processed in the first processing item.

In some embodiments of the present disclosure, a second control is displayed in the information interface, and the second control is configured to edit the basic information after being triggered. In some embodiments, the second control is, for example, “Edit” displayed to the right of “Basic Information” at the upper right corner of FIG. 9, and the basic information can be edited by triggering the second control. If the subordinate department displayed in the information interface satisfies a second preset condition, the second control is displayed; otherwise, the second control is not displayed or cannot be triggered. The second preset condition includes at least one of the following: the subordinate department is in an activated status, the subordinate department is not in a deactivation processing flow, and the subordinate department is not in a change processing flow. In some embodiments, if the subordinate department is currently deactivated, the second control cannot be triggered, and the second control can be grayed out. When the control indicator hovers over the second control, a prompt information for prompting that the subordinate department has been deactivated is displayed. If the subordinate department is in a deactivation processing flow, it indicates that the subordinate department has been applied for deactivation. At this time, the second control is unavailable and can be grayed out. When the control indicator hovers over the second control, a prompt information can be displayed, for example, indicating that the subordinate department is in a deactivation processing flow, and the prompt information can have a control or link for contacting the initiator of the deactivation processing. In some embodiments, if the subordinate department is in a change processing flow, it indicates that the subordinate department is being changed, such as changing its hierarchical relationship. At this time, the second control is unavailable and can be grayed out; when the mouse hovers over the second control, a prompt information is displayed to remind that the subordinate department is in a change processing flow, and a control or link for contacting the initiator of the change processing item can be displayed in the prompt information. In some embodiments of the present disclosure, among the subordinate departments displayed in the information interface, the subordinate department that is adjusted in the first processing item will be preferentially displayed.

In some embodiments of the present disclosure, a third control associated with a department member is displayed in the information interface, and the third control is used for personnel change processing of the associated department member. In some embodiments, as shown in FIG. 9, the third control is displayed in the area corresponding to the “Operation” column at the right side of the member in the member list displayed in the information interface. By triggering this third control, the corresponding department member is subject to personnel change processing. Personnel change processing refers to changing the information of the department member in the organizational structure, such as changing the organization department to which he/she belongs. In some embodiments, as shown in FIG. 10, a plurality of department members displayed in the information interface can be selected. After a plurality of department members is selected, a control for personnel change processing of the selected department members in batch is displayed, that is, “Batch Edit” shown in FIG. 10. After the control is triggered, the selected department members can be subjected to personnel change processing in a united manner, thus improving the processing efficiency.

In some embodiments of the present disclosure, among the members displayed in the information interface, the member in a personnel change status is preferentially displayed. In some embodiments, the personnel change status means that the member of the department has undergone personnel change processing, and the personnel change processing is in progress and has not been completed. In some embodiments, if a department member is transferred to this department through an adjustment in the first processing item, a label for identifying the department member as a personnel change is displayed at a position associated with the department member.

In some embodiments of the present disclosure, the information interface displays a fourth control associated with the subordinate departments, and the fourth control is configured to edit the associated subordinate departments after being triggered. In some embodiments, there is also a control in the pattern for editing the corresponding organization department. The fourth control is, for example, the “Edit” operation displayed at the right side of each department displayed in “Subordinate Departments” in FIG. 11. After the fourth control is triggered, as shown in FIG. 12, an edition interface is displayed for editing the organization department.

In some embodiments of the present disclosure, as shown in FIG. 13, the subordinate departments displayed in the information interface can be selected. If at least two subordinate departments displayed in the information interface are selected, a fifth control is displayed, and the fifth control is configured to edit the selected subordinate departments in batch after being triggered (“Batch Edit” button in FIG. 13). In this embodiment, when at least two subordinate departments are selected, the fifth control can be displayed, otherwise, the fifth control is not displayed; and a pop-up window for batch editing appears when the fifth control is triggered. In some embodiments, if the selected subordinate department satisfies a second preset condition, the fifth control is displayed; otherwise, the fifth control is not displayed or the fifth control cannot be triggered. In some embodiments, the second preset condition includes at least one of the following: the subordinate department is in an activated status, the subordinate department is not in a deactivation processing item, and the subordinate department is not in a change processing item. In some embodiments, if the subordinate department is currently deactivated, the fifth control cannot be triggered, and the fifth control can be grayed out; and when the control indicator hovers over the fifth control, a prompt information for prompting that the subordinate department has been deactivated is displayed. If the subordinate department is in a deactivation processing item, it indicates that the subordinate department has been applied for deactivation. At this time, the fifth control is unavailable and can be grayed out; and when the control indicator hovers over the fifth control, a prompt information can be displayed, for example, indicating that the subordinate department is in a deactivation processing flow; and the prompt information can have a control or link for contacting the initiator of the deactivation processing flow. In some embodiments, if the subordinate department is in a change processing item, it indicates that the subordinate department is being changed; at this time, the fifth control is unavailable and can be grayed out; and when the mouse hovers over the fifth control, a prompt information is displayed to prompt that the subordinate department is in a change processing item, and a control or link for contacting the initiator of the change processing item can be displayed in the prompt information. In some embodiments of the present disclosure, among the subordinate departments displayed in the information interface, a subordinate department adjusted in the first processing item is preferentially displayed. After displaying the pop-up window for batch editing, if a verification is passed, the pop-up window will be closed, the information interface will be refreshed, and a prompt information can be issued.

In some embodiments of the present disclosure, in response to the second operation event based on the pattern, the first processing item for adjusting the organizational structure is generated, including: in response to dragging a first pattern to be under a second pattern, adjusting the organization department corresponding to the first pattern to the subordinate department of the organization department corresponding to the second pattern. In some embodiments, the first pattern and the second pattern can be arbitrary patterns. Reference can be made to FIGS. 14 and 15. In FIG. 14, the pattern of Department 4 is dragged to be under the pattern of Department 3 by means of a control indicator (the mouse cursor in the Figure; the pattern can also be dragged by touch control), and both the dragged pattern and the target pattern (i.e., the pattern of Department 3) are displayed differently from other patterns during the dragging operation. Then, as shown in FIG. 15, the dragged pattern is displayed below the target pattern, so as to complete the adjustment of the hierarchical relationship of the organization department. The first pattern and the second pattern can be patterns of any organization department.

In some embodiments of the present disclosure, at least one of the following is satisfied; otherwise, the dragging fails, or the dragging fails and the corresponding first prompt information is displayed; the organization department corresponding to the first pattern is in an activated status, the organization department corresponding to the first pattern is not a root node organization department, the organization department corresponding to the first pattern is not in a change processing flow, the organization department corresponding to the first pattern is not in a deactivation processing flow, the organization department corresponding to the second pattern is in an activated status, the organization department corresponding to the second pattern is not a direct superior department of the organization department corresponding to the first pattern, the organization department corresponding to the second pattern is not a subordinate department of the organization department corresponding to the first pattern; the current user has a first authority with respect to the organization department corresponding to the second pattern. In some embodiments, a verification is required when dragging; it's required that the department corresponding to the dragged pattern is in an activated status, is not a root node department, and has no ongoing change processing flow and deactivation processing flow; it's required that the department corresponding to the target pattern (i.e., the pattern under which the dragged pattern will be located after dragging) is in an activated status, and is not a direct superior department or a direct or indirect subordinate department of the department corresponding to the dragged pattern. This is because: in addition to the organization department corresponding to the dragged pattern, the subordinate department of the organization department corresponding to the target pattern is still a subordinate department of the organization department corresponding to the dragged pattern; if the organization department corresponding to the target pattern is a subordinate department of the organization department corresponding to the dragged pattern, the hierarchical relationship will form a loop. In some embodiments, an error is reported if the department corresponding to the dragged pattern or the department corresponding to the target pattern has been deactivated; an error is reported if the current user does not have the first authority with respect to the organization department corresponding to the target pattern; an error is reported if the organization department corresponding to the dragged pattern is a root node department, i.e., it's a direct or indirect superior department of all other organization departments; and a prompt information is displayed if the organization department is in a deactivation processing flow or a change processing flow, and the displayed prompt information includes a link or a control for contacting the initiator of the flow.

In some embodiments of the present disclosure, after the organization department corresponding to the first pattern is adjusted as the subordinate department of the organization department corresponding to the second pattern, a first mark is displayed in the associated area of the first pattern, and the first mark is configured to identify that the organization department corresponding to the first pattern has changed. Specifically, reference can be made to FIG. 15. The “change”, that is, the first mark, is displayed above the Department 4. The first mark is configured to explain that this pattern is changed to this position this time. In some embodiments, as shown in FIG. 16, the pattern processed by the first processing item has an associated identifier, which is configured to identify the type of the adjustment processing being carried out by the first processing item. For example, “New” above the pattern of Department 5 in FIG. 16 indicates that the Department 5 is an organization department newly created in the first processing item; and “Deactivated” above the pattern of Department 4 in FIG. 16 indicates that the Department 4 is deactivated, and other patterns cannot be dragged to be under the pattern corresponding to the deactivated department at this time.

In some embodiments of the present disclosure, in response to the second operation event based on the pattern, the first processing item for adjusting the organizational structure is generated, including: in response to dragging the subordinate department displayed in the information interface to the third pattern, adjusting the dragged subordinate department as the subordinate department of the organization department corresponding to the third pattern. In some embodiments, reference can be made to FIG. 17. The subordinate departments of the organization department are displayed in the information interface. One or more subordinate departments in the information interface can be dragged to be under the pattern in the adjustment interface. The third pattern can be the pattern of any organization department. By dragging the subordinate departments displayed in the information interface, the hierarchical relationship of departments in the organizational structure can also be adjusted.

In some embodiments of the present disclosure, at least one of the following is satisfied; otherwise, the dragging fails, or the dragging fails and a corresponding second prompt information is displayed: the dragged subordinate department is in an activated status, the dragged subordinate department is not in a deactivation processing flow, the dragged subordinate department is not in a change processing flow; the organization department corresponding to the third pattern is in an activated status, the organization department corresponding to the third pattern is not a direct superior of the dragged subordinate department, the organization department corresponding to the third pattern is not a subordinate department of the dragged subordinate department. In some embodiments, when dragging the subordinate departments in the information interface, it needs to be verified according to the above-mentioned rules. If the above-mentioned rules are not satisfied, the dragging fails, the organizational structure cannot be adjusted, and prompt information can be displayed.

In some embodiments of the present disclosure, after dragging the subordinate department to be under the organization department corresponding to the third pattern, it is determined that the organization department corresponding to the third pattern satisfies a third preset condition; otherwise, a third prompt information is sent. The third preset condition includes at least one of the following: the organization department corresponding to the third pattern is not in a deactivation processing flow, and the organization department corresponding to the third pattern has no deactivated version in future. In some embodiments, after dragging, it is verified whether the above conditions are satisfied; if not, an error is reported, and it can be judged that the dragging has failed.

In some embodiments of the present disclosure, at least one of the following is displayed in a pattern or in an associated area of the pattern: a sixth control for activating an organization department, a seventh control for deactivating an organization department, and an eighth control for deleting an organization department. In some embodiments, reference can be made to FIG. 18. After the option control “ . . . ” in the pattern is triggered, the seventh control “Deactivate Department” and the eighth control “Delete Department” are displayed, so that the organization department corresponding to the patterns can be deactivated and deleted. Among them, for the sixth control, it is configured to activate an organization department corresponding to the pattern; if the organization department corresponding to the pattern is in a deactivated status, the sixth control is displayed; otherwise, the sixth control is not displayed, because it is not necessary to display the sixth control for a department in an activated status.

In some embodiments, if the organization department corresponding to the pattern satisfies a fourth preset condition, a seventh control is displayed; otherwise, the seventh control is not displayed or the seventh control is unavailable, wherein the fourth preset condition includes at least one of the following: the organization department is in an activated status, the organization department is not in a deactivation processing flow, the organization department is not in a change processing flow, the organization department has no activated version in future, the organization department has no subordinate department activated currently and in future, the organization department has no current and future employee, and the organization department has no department member in a personnel change status. In some embodiments, if the organization department corresponding to the pattern is in a deactivated status, the seventh control is not displayed; if the organization department corresponding to the pattern is in a deactivation processing flow, the seventh control is unavailable, and a prompt information is displayed when the control indicator hovers over the seventh control, and a control or link for contacting the initiator of the deactivation processing flow can be displayed in the prompt information. In some embodiments, if the organization department corresponding to the pattern is in a change processing flow, the seventh control is unavailable; and when the control indicator hovers over the seventh control, a prompt information is displayed, in which a control or link for contacting the initiator of the change processing flow can be displayed. In some embodiments, if the department corresponding to the pattern has an activated version in future, or has an activated subordinate department or an in-service employee, the seventh control is unavailable, and a prompt information is sent when the control indicator hovers over the seventh control; if there is a personnel change, that is, if there is a department member in the process of transferring out or in, the seventh control is unavailable, and a control or link for contacting the initiator of the personnel change processing flow is displayed when the control indicator hovers over the seventh control. In some embodiments, after the seventh control is triggered, a pop-up window will be displayed for confirmation.

In some embodiments of the present disclosure, if the organization department corresponding to the pattern satisfies a fifth preset condition, an eighth control is displayed; otherwise, the eighth control is not displayed or the eighth control is unavailable, wherein the fifth preset condition includes at least one of the following: the organization department is newly created in the first processing item, the organization department has no subordinate department, and the organization department has no department member in a personnel change status. In some embodiments, the eighth control is not displayed if the organization department is not a newly created organization department in the first processing item; the eighth control is unavailable if the organization department has a subordinate department or an employee who is transferred in, and a prompt information is displayed when the control indicator hovers over the eighth control. In some embodiments, the personnel change status means that the department member is in a personnel change processing, for example, changing the organization department he/she belongs, including transferring in and out of the organization department, change of post and the like.

In some embodiments of the present disclosure, the first processing item for adjusting the organizational structure is saved in real time or regularly. In some embodiments, the adjustments made to the organizational structure will be saved in a back end to prevent from data loss.

In some embodiments of the present disclosure, if the user exits the adjustment of the organizational structure before saving the first processing item, a saving interface for saving the first processing item is displayed. In some embodiments, as shown in FIG. 19, when the adjustment of the organizational structure is exited, a saving interface will be displayed to determine whether to keep this adjustment, that is, whether to keep the first processing item, and the first processing item can be named. The first processing item that has not started the processing flow can be saved in the cloud.

In some embodiments of the present disclosure, after the user saves the first processing item, if the adjustment of the organizational structure is exited, a fourth prompt information is displayed. In some embodiments, after the user saves the first processing item, if the adjustment is exited, a prompt will be displayed through a pop-up window, which can remind that the first processing item has been saved and can be viewed and edited at a predetermined location after exiting.

In some embodiments of the present disclosure, if the adjustment of the organizational structure is abnormally exited, a continuous processing interface is displayed when the adjustment interface of the organizational structure is re-entered, and the continuous processing interface is configured to determine whether to continue to execute the first processing item. In some embodiments, when the user opens an adjustment page of the organizational structure, if there is unfinished processing item that has not been submitted or actively saved, a pop-up window will be displayed to inform that there is unfinished processing item; the unfinished processing item can be named according to the last exiting time, and the user can choose to continue the last processing item through this pop-up window, so as to continue to adjust the organizational structure.

In some embodiments of the present disclosure, after the pattern is triggered, the information interface of the corresponding organization department is displayed, and the information interface of the organization department displays the department member. The department member has an associated third control, and the third control is configured to perform personnel change processing on the associated department member. In some embodiments, as shown in FIG. 20, the third control can be “Personnel Change” in the “Operation” column displayed in the information interface in FIG. 20. After the third control is triggered, as shown in FIG. 20, the personnel change processing interface is displayed, in which the direct superior, department and post can be selected for the department member.

In some embodiments of the present disclosure, a department member has an associated ninth control, the ninth control is configured to select the associated department member; and after the ninth control is selected, a tenth control is displayed, and the tenth control is configured to perform personnel change processing on the selected department member associated with the ninth control. In some embodiments, as shown in FIG. 10, the ninth control can be the option box to the left of the department member displayed in the information interface. When the corresponding department members are selected through the option box, the “Batch Edition”, i.e., the tenth control as shown in FIG. 10 can be displayed, and the selected department members can be subjected to personnel change processing in a unified manner through the tenth control. As it can be seen in FIG. 21 which shows the display interface of personnel change processing in batch, if there is an immovable department member, a prompt information will be displayed, and a control for performing personnel change processing on movable department member only is provided so that the operation of the user can be reduced because it has no need of reselecting the department member. In FIG. 22, Li Yi, Li Er, Li San and Li Si are selected for personnel change processing in a unified manner.

In some embodiments of the present disclosure, if a department member is dragged to be under a displayed pattern, the dragged department member is subjected to personnel change processing according to the organization department associated with the target pattern (i.e., the above-mentioned displayed pattern). In some embodiments, the organization departments to which the department members belong can be adjusted by dragging the department members in the information interface, for example, adjusting the dragged department member to the organization department corresponding to the target pattern.

In some embodiments of the present disclosure, if the department member satisfies a sixth preset condition, the associated third control is displayed; otherwise, the third control is hidden or unavailable. The sixth preset condition includes at least one of the following: the department member has no personnel change processing item, no resignation processing item and no ineffective employment item. In some embodiments, if the sixth preset condition is not satisfied, a prompt information will be displayed, and a control or link for contacting an initiator of the corresponding processing item will be displayed in the prompt information.

In some embodiments of the present disclosure, if the department member satisfies the sixth preset condition, the associated ninth control is displayed; otherwise, the ninth control is hidden or unavailable. The sixth preset condition includes at least one of the following: the department member has no personnel change processing item, no resignation processing item and no ineffective employment item. In some embodiments of the present disclosure, after the tenth control is triggered, if the selected ninth control does not satisfy the sixth preset condition, a fifth prompt information is displayed and no personnel change processing is performed. In some embodiments, if the sixth preset condition is not satisfied, a prompt information will be displayed, and a control or link for contacting an initiator of the corresponding processing item will be displayed in the prompt information.

In some embodiments of the present disclosure, if the department associated with the target pattern does not satisfy a seventh preset condition, a sixth prompt information is displayed and no personnel change processing is performed. The seventh preset condition includes at least one of the following: the organization department associated with the target pattern is in an activated status, the organization department associated with the target pattern is not an organization department to which the dragged department member currently belongs, the organization department associated with the target pattern has no deactivated version in future, and the organization department associated with the target pattern has no deactivation processing item. In some embodiments, if the seventh preset condition is not satisfied, an error is reported.

In some embodiments, after personnel change processing is performed on a department member, a personnel change mark is displayed in an associated area of the department member in the information interface to identify that the department member has made a personnel change.

In some embodiments, as shown in FIG. 21, when there is a department member who cannot be moved among the department members preparing for personnel change processing, a prompt window is displayed to identify the department member who cannot be subjected to personnel change processing, and a control for performing personnel change processing on other department members is displayed.

In some embodiments, after generating the first processing item for adjusting the organizational structure and before responding to the third operation event, it further includes: in response to a trigger operation on an eleventh control, displaying an adjustment record page, wherein the adjustment record page displays an adjustment content carried out in the first processing item. In some embodiments, the eleventh control can be “Next” displayed at the upper right corner of FIG. 18. By triggering the eleventh control, it indicates that the first processing item has been generated. However, before the first processing item is started, that is, before the processing flow of the first processing item is started, the first processing item needs to be checked and confirmed; correspondingly, at this time, as shown in FIG. 23, the adjustment content in the first processing item will be displayed, including the adjustment of the organization department and the adjustment of the department member; and the adjustment includes change.

In some embodiments, as shown in FIG. 23, the adjustment contents carried out in the first processing item and displayed in the adjustment record page include at least one of adjustment records of organization departments and personnel change records of department members. The adjustment record of an organization department includes at least one of adjustment type, department name, superior department, head, code number, department description, confidentiality status, edition control and removal control. In the adjustment record of an organization department, when the adjustment type is “change”, the information before and after the change will be displayed. For the content without code number, “no change” can be displayed in one line. For the changed content, it can be highlighted. In some embodiments, according to the adjustment type of the adjustment record of the organization department, a corresponding operation control will be displayed; for the newly-created organization department, the edition control and the removal control will be displayed; for the deactivated organization department, the removal control can be displayed but the edition control will not be displayed. The adjustment records of organization departments can be sorted in the following order of adjustment types: new creation, deactivation and change; and the adjustments of the same type can be sorted according to the operation time. After the edition control is triggered, the edition interface of the organization department is displayed, such as the interface shown in FIG. 12, so as to edit the organization department. After the removal control is triggered, the corresponding adjustment record (that is, the adjustment content of the organization department) is removed. In some embodiments, if the organization department corresponding to the adjustment record satisfies an eighth preset condition, the removal control in the adjustment record of the organization department is unavailable; the eighth preset condition includes: the organization department is a newly-created organization department with subordinate department, the organization department is a newly-created organization department with department member transferred in personnel change, the superior department of the organization department before adjustment has been deactivated, and the hierarchical relationship of the organization department forms a closed loop after the adjustment record is removed, that is, one organization department is both a superior department and a subordinate department of another organization department, resulting in a cycle of hierarchical relationship. In some embodiments, a newly created organization department refers to an organization department newly created in the first processing item. In some embodiments, when the eighth preset condition is not satisfied, a prompt information will be sent, and the reason why the removal control cannot be triggered can be displayed in the prompt information.

In some embodiments, the personnel change records of department members include at least one of name, information before personnel change, information after personnel change, edition control and removal control. In some embodiments, as shown in FIG. 23, the personnel change records of department members are displayed in two lines, which respectively show the information before and after the personnel change. After the edition control is triggered, the personnel change processing interface as shown in FIG. 20 can be displayed, so as to modify the personnel change processing of department members. In some embodiments, if the organization department to which the department member corresponding to the personnel change record originally belongs is deactivated in the first processing item, the removal control of the personnel change record is unavailable, because the organization department to which the department member originally belongs is deactivated at this time and the department member is not allowed to transfer in, but if the transfer record is removed, the department member needs to be transferred to the original organization department, which leads to contradictions; therefore, the removal control is unavailable at this time, and if the control indicator hovers over the removal control, a prompt information can be displayed to indicate the reason why the removal control is unavailable.

In some embodiments of the present disclosure, the processing flow of the first processing item is triggered in response to the third operation event, including: displaying a submission interface in response to a trigger operation on an eleventh control, and triggering the processing flow of the first processing item in response to a confirmation operation on the submission interface. At least one of the following is displayed in the submission interface: subject name, effective time and adjustment reason. In some embodiments, as shown in FIG. 24, the “Submit” at the upper right corner, that is, the eleventh control can be clicked to pop up the submission interface as shown in FIG. 24, which is configured to submit a processing request for the first processing item. The first processing item can be named in the submission interface, and the effective time of the first processing item and the reason for adjustment can be filled in, so as to facilitate the personnel at all nodes of the processing flow to handle it.

In some embodiments of the present disclosure, after the processing flow of the first processing item is triggered, if there are conflicting adjustment contents in the first processing item, a conflict information interface is displayed, and the conflicting adjustment contents are displayed in the conflict information interface. In some embodiments, after the processing request for the first processing item is submitted, that is, after the processing flow is triggered, the first processing item will be verified to determine whether there is a conflict in the adjustment content. If there is a conflict, as shown in FIG. 25, the conflicting adjustment content can be displayed, a prompt information can be displayed in the conflict information interface, and a control for removing all conflicting adjustment contents can be displayed in the conflict information interface. After the control is triggered, all conflicting adjustments are removed. In some embodiments, the adjustment content displayed in the conflict information interface has at least one of an associated control for editing the adjustment content and an associated control for removing the adjustment content, through which the conflicting adjustment content can be modified and removed to pass the verification. If the verification is successful, a prompt information will be displayed.

In some embodiments of the present disclosure, after triggering the processing flow of the first processing item, it further includes: in response to a trigger operation on a twelfth control, displaying a processing item interface, in which a processing item record initiated by the current user is displayed. In some embodiments, as shown in FIG. 26, the user can click “Adjustment Record” at the upper right of the related page in the “Organizational Structure” shown in FIG. 2, so as to display the processing item interface at the right side in FIG. 26, in which the current user's related processing items are displayed, including subject name, current status, effective time, creation time and related operation of the processing item. For the processing items displayed in the processing item interface, according to their current statuses, a control for viewing the processing items, a control for editing the processing items and a control for deleting the processing items are displayed; for ongoing and completed processing items, it can display the control for viewing processing items, while for processing items to be submitted, it can provide the control for editing processing items and the control for deleting processing items. In some embodiments, as shown in FIG. 26, if there are conflicting adjustment contents in the processing items displayed in the processing item interface, a prompt sign is displayed. In FIG. 26, the prompt sign is a circle with an exclamation mark displayed in the associated area of the processing items, and the user is informed by the prompt sign that there is a conflict in the processing items and needs to be modified; otherwise, the verification is passed. In some embodiments, as shown in FIG. 27, after the prompt sign is triggered, a prompt information can be displayed, which can inform the number of the conflict and can also show how to solve the conflict. In some embodiments, for the processing items with conflicts, when the associated control for editing the processing items is triggered, a conflict information interface can be displayed as shown in FIG. 28, which displays the adjustment contents of the conflicts, and can also provide a control for removing all the conflicts.

In some embodiments of the present disclosure, after the control displayed in the processing item interface for viewing the processing items is triggered, a processing item status interface is displayed. The processing item status interface displays at least one of the following: summary information of the processing item, a control for withdrawing the processing item, a control for viewing the processing flow, a control for viewing the processing result at each node of the processing flow, adjustment records in the processing item, a control for editing the adjustment records, and a control for removing the adjustment records. In some embodiments, for the case where the processing flow is an approval flow, by way of example, as shown in FIG. 29, a processing item status interface is displayed in the form of a card, in which the effective time, adjustment reason and approval content of the processing item can be displayed. The approval content can display an approval summary including the number of department adjustments, the number of personnel changes of department members, and the current approval status; the approval content also provides a control for withdrawing the processing item, which control is only displayed when the processing flow of the processing item is under an approval, and will not be displayed if the processing flow of the processing item has not been initiated or has been ended; the approval content also provides a control for viewing an approval form.

In some embodiments of the present disclosure, triggering the processing flow of the first processing item includes: determining the lowest-level public department involved in the first processing item and configuring the processing flow based on the lowest-level public department; among them, the lowest-level public department is the lowest-level organization department involved in the first processing item. In some embodiments, the process of the processing flow involves the lowest-level public department, and the determination of the lowest-level public department can be as follows: a) determining the departments adjusted in the first processing item; b) determining the departments before and after the personnel change processing; then regarding the lowest-level public department determined from these departments in steps a) and b) as the lowest-level public department, and configuring the processing flow based on the lowest-level public department, for example, starting with the lowest-level public department.

In some embodiments, reference can be made to FIG. 30. For the case where the processing flow is an approval flow by way of example, the display interface of the processing flow is displayed, in which the basic information of the processing items, the adjustment contents involved, the processed nodes and the processing results will be displayed, so as to facilitate the current user to process the processing flow.

In some embodiments of the present disclosure, after triggering the processing flow of the first processing item, it further includes: sending a notification message to the initiator of the first processing item in response to a generation of the processing result of the first processing item, and viewing the details of the processing result after the notification message is triggered. In some embodiments, if the first processing item fails, a notification message is sent to the initiator of the first processing item to inform that it failed, and the details of the specific failure can be viewed after the notification message is triggered. After the first processing item passes, a notification message can also be sent, in which the summary information of the adjustment content of the first processing item can be informed, and the details can be viewed after the notification message is triggered. However, if the processing flow of the first processing item passes but some adjustment contents fail to be executed, a notification message is sent to inform that the adjustment contents fail to be executed, and the details can be viewed after the notification message is triggered. In some embodiments, the adjustment contents fail to be executed because of conflicts, and the conflicting adjustment contents can be highlighted when the details are viewed; specifically, as shown in FIG. 31, an identifier is displayed in the associated area of the adjustment contents that failed to be executed, and the reasons for the execution failure can be displayed after the identifier is triggered.

The present disclosure also provides an information processing apparatus, including:
a display unit, configured to display an adjustment interface of an organizational structure in a display interface in response to a first operation event, wherein a pattern of an organization department in the organizational structure is displayed in the adjustment interface, and the pattern is displayed according to a hierarchical relationship of the organization department;
a control unit, configured to generate a first processing item for adjusting the organizational structure in response to a second operation event based on the pattern; and
a processing unit, configured to trigger a processing flow of the first processing item in response to a third operation event.

In some embodiments, at least one of the following is satisfied: displaying, in the adjustment interface, only the pattern of the organization department currently in an activated status; displaying, in the adjustment interface, only the organization department within a scope of authority of a current user; displaying, in the adjustment interface, the pattern in a form of a tree structure diagram according to the hierarchical relationship of the organization department; displaying, in the pattern, a name, a head and a number of department member of a corresponding organization department; and the adjustment interface is provided with a search control for searching according to the organization department or the head.

In some embodiments, the display unit is also configured to display a guidance interface when the user opens the adjustment page of the organizational structure for the first time, and the guidance interface is configured to show the operation mode of the adjustment page of the organizational structure.

In some embodiments, in response to the second operation event based on the pattern, the first processing item for adjusting the organizational structure is generated, including: in response to the trigger operation on the first control of the first pattern, creating a subordinate department of the organization department corresponding to the first pattern and displaying the pattern of the created subordinate department.

In some embodiments, if the organization department corresponding to the first pattern satisfies a first preset condition, a first control is displayed; otherwise, the first control is not displayed or cannot be triggered.

In some embodiments, the first preset condition includes at least one of the following: the organization department is in an activated status, the organization department has no deactivated version in future, and the organization department is not in a deactivation processing flow.

In some embodiments, if the pattern is triggered, an information interface of the organization department corresponding to the triggered pattern is displayed; the information interface displays the information of the organization department corresponding to the pattern.

In some embodiments, the information interface displays at least one of the following: basic information of the organization department, department members of the organization department, and subordinate departments of the organization department.

In some embodiments, at least one of the following is satisfied:
a second control is displayed in the information interface, and the second control is configured to edit the basic information after being triggered;
a third control associated with the department members is displayed in the information interface, and the third control is used for personnel change processing of the associated department members;
among the members displayed in the information interface, the member in a personnel change status is displayed preferentially;
among the subordinate departments displayed in the information interface, the subordinate department adjusted in the first processing item is preferentially displayed;
a fourth control associated with the subordinate departments is displayed in the information interface, and the fourth control is configured to edit the associated subordinate departments after being triggered;
if at least two subordinate departments displayed in the information interface are selected, a fifth control is displayed, and the fifth control is configured to edit the selected subordinate departments in batch after being triggered.

In some embodiments, at least one of the following is satisfied:
if the subordinate department displayed in the information interface satisfies a second preset condition, the second control is displayed; otherwise, the second control is not displayed or cannot be triggered;
if the selected subordinate department satisfies a second preset condition, a fifth control is displayed; otherwise, the fifth control is not displayed or cannot be triggered.

In some embodiments, the second preset condition includes at least one of the following: the subordinate department is in an activated status, the subordinate department is not in a deactivation processing flow, and the subordinate department is not in a change processing item.

In some embodiments, in response to the second operation event based on the pattern, the first processing item for adjusting the organizational structure is generated, including: in response to dragging a first pattern to be under a second pattern, adjusting the organization department corresponding to the first pattern as a subordinate department of the organization department corresponding to the second pattern.

In some embodiments, at least one of the following is satisfied; otherwise, the dragging fails, or the dragging fails and a corresponding first prompt information is displayed;
the organization department corresponding to the first pattern is in an activated status, the organization department corresponding to the first pattern is not a root node organization department, the organization department corresponding to the first pattern is not in a change processing flow, and the organization department corresponding to the first pattern is not in a deactivation processing flow;
the organization department corresponding to the second pattern is in an activated status, the organization department corresponding to the second pattern is not a direct superior department of the organization department corresponding to the first pattern, and the organization department corresponding to the second pattern is not a subordinate department of the organization department corresponding to the first pattern;
the current user has a first authority with respect to the organization department corresponding to the second pattern.

In some embodiments, the display unit is further configured to display a first mark in the associated area of the first pattern after the organization department corresponding to the first pattern is adjusted as the subordinate department of the organization department corresponding to the second pattern, and the first mark is configured to identify that the organization department corresponding to the first pattern has changed.

In some embodiments, in response to the second operation event based on the pattern, the first processing item for adjusting the organizational structure is generated, including: in response to dragging the subordinate department displayed in the information interface to be under a third pattern, adjusting the dragged subordinate department as a subordinate department of the organization department corresponding to the third pattern.

In some embodiments, at least one of the following is satisfied; otherwise, the dragging fails, or the dragging fails and a corresponding second prompt information is displayed:
the dragged subordinate department is in an activated status, the dragged subordinate department is not in a deactivation processing flow, and the dragged subordinate department is not in a change processing flow;
the organization department corresponding to the third pattern is in an activated status, the organization department corresponding to the third pattern is not a direct superior of the dragged subordinate department, and the organization department corresponding to the third pattern is not a subordinate department of the dragged subordinate department.

In some embodiments, the control unit is further configured to determine that the organization department corresponding to the third pattern satisfies a third preset condition after dragging the subordinate department to be under the organization department corresponding to the third pattern; otherwise, sending out a third prompt information;
the third preset condition includes at least one of the following: the organization department corresponding to the third pattern is not in a deactivation processing flow, and the organization department corresponding to the third pattern has no deactivated version in future.

In some embodiments, at least one of a sixth control for activating an organization department, a seventh control for deactivating an organization department, and an eighth control for deleting an organization department is displayed in a pattern or an associated area of the pattern.

In some embodiments, the display unit is further configured to display the sixth control if the organization department corresponding to the pattern is in a deactivated status; otherwise, the sixth control is not displayed;
in some embodiments, the display unit is further configured to display the seventh control if the organization department corresponding to the pattern satisfies a fourth preset condition; otherwise, the seventh control is not displayed or the seventh control is unavailable; the fourth preset condition includes at least one of the following: the organization department is in an activated status, the organization department is not in a deactivation processing flow, the organization department is not in a change processing flow, the organization department has no activated version in future, the organization department has no current and future activated subordinate department, the organization department has no current and future employee, and the organization department has no department member in a personnel change status;
in some embodiments, the display unit is further configured to display an eighth control if the organization department corresponding to the pattern satisfies a fifth preset condition; otherwise, the eighth control is not displayed or the eighth control is unavailable; the eighth control includes at least one of the following: the organization department is newly created in the first processing item, the organization department has no subordinate department, and the organization department has no department member in a personnel change status.

In some embodiments, the control unit is also configured to save the first processing item that adjusts the organizational structure in real time or at a fixed time;
in some embodiments, the display unit is further configured to display a saving interface for saving the first processing item if the user exits the adjustment of the organizational structure before saving the first processing item;
in some embodiments, the display unit is further configured to display a fourth prompt information if the user exits the adjustment of the organizational structure after saving the first processing item;
in some embodiments, the display unit is further configured to display a continuous processing interface when the adjustment interface of the organizational structure is re-entered if the adjustment of the organizational structure is abnormally exited, and the continuous processing interface is configured to determine whether to continue to execute the first processing item.

In some embodiments, after the pattern is triggered, the information interface of the corresponding organization department is displayed, and the information interface of the organization department displays department members and satisfies at least one of the following:
the department member has an associated third control, and the third control is configured to perform personnel change processing on the associated department member;
the department member has an associated ninth control, the ninth control is configured to select the associated department member; and after the ninth control is selected, a tenth control is displayed, and the tenth control is configured to perform personnel change processing on the selected department member associated with the ninth control;
if a department member is dragged to be under the displayed pattern, the control unit is configured to perform personnel change processing on the dragged department member according to the organization department associated with the target pattern (i.e., the displayed pattern).

In some embodiments, at least one of the following is satisfied:
the display unit is also configured to display the associated third control if the department member satisfies a sixth preset condition; otherwise, the third control is hidden or unavailable;
the display unit is also configured to display the associated ninth control if the department member satisfies the sixth preset condition; otherwise, the ninth control is hidden or unavailable;
the display unit is also configured to display a fifth prompt information without personnel change processing if the selected ninth control does not satisfy the sixth preset condition after the tenth control is triggered;
the display unit is also configured to display a sixth prompt information without personnel change processing if the department associated with the target pattern does not satisfy a seventh preset condition.

In some embodiments, the sixth preset condition includes at least one of the following: the department member has no personnel change processing item, the department member has no resignation processing item, and the department member has no ineffective employment item;
the seventh preset condition includes at least one of the following: the organization department associated with the target pattern is in an activated status, the organization department associated with the target pattern is not the organization department to which the dragged department member currently belongs, the organization department associated with the target pattern has no deactivated version in future, and the organization department associated with the target pattern has no deactivation processing item.

In some embodiments, after generating the first processing item for adjusting the organizational structure and before responding to the third operation event, the display unit is further configured to display an adjustment record page in response to a trigger operation on an eleventh control, wherein the adjustment record page displays the adjustment content carried out in the first processing item.

In some embodiments, the adjustment contents carried out in the first processing item and displayed in the adjustment record page include at least one of the adjustment records of the organization departments and the personnel change records of the department members;
the adjustment record of an organization department includes at least one of adjustment type, department name, superior department, head, code number, department description, confidentiality status, edition control and removal control;
the personnel change record of a department member includes at least one of name, information before personnel change, information after personnel change, edition control and removal control.

In some embodiments, at least one of the following is satisfied:
if the organization department corresponding to the adjustment record satisfies an eighth preset condition, the removal control in the adjustment record of the organization department is unavailable; the eighth preset condition includes: the organization department is a newly-created organization department with subordinate department, the organization department is a newly-created organization department with department member transferred in personnel change, the superior department of the organization department before the adjustment has been deactivated, and the hierarchical relationship of the organization department forms a closed loop after the adjustment record is removed;
if the organization department to which the department member corresponding to the personnel change record originally belongs is deactivated in the first processing item, the removal control of the personnel change record is not available.

In some embodiments, the processing flow of the first processing item is triggered in response to the third operation event, including: displaying a submission interface in response to a trigger operation on an eleventh control, and triggering the processing flow of the first processing item in response to a confirmation operation on the submission interface;
at least one of the following is displayed in the submission interface: subject name, effective time and adjustment reason.

In some embodiments, the display unit is further configured to display a conflict information interface if there are conflicting adjustment contents in the first processing item after triggering the processing flow of the first processing item, and display the conflicting adjustment contents in the conflict information interface.

In some embodiments, the conflict information interface displays a control for removing all conflicting adjustment contents;
the adjustment content displayed in the conflict information interface has at least one of an associated control for editing the adjustment content and an associated control for removing the adjustment content.

In some embodiments, the display unit is further configured to display a processing item interface in response to a trigger operation on a twelfth control after the processing flow of the first processing item is triggered, and a processing item record initiated by the current user is displayed in the processing item interface.

In some embodiments, at least one of the following is satisfied:
the processing item displayed in the processing item interface displays at least one of a control for viewing the processing item, a control for editing the processing item and a control for deleting the processing item, according to the current status;
if there are conflicting adjustment contents in the processing items displayed in the processing item interface, a prompt sign will be displayed.

In some embodiments, the display unit is further configured to display a processing item status interface after the control for viewing the processing item displayed in the processing item interface is triggered;
the processing item status interface displays at least one of the following: summary information of the processing item, a control for withdrawing the processing item, a control for viewing the processing flow, a control for viewing the processing results of each node of the processing flow, adjustment records in the processing item, a control for editing the adjustment records, and a control for removing the adjustment records.

In some embodiments, triggering the processing flow of the first processing item includes:
determining a lowest-level public department involved in the first processing item, and configuring the processing flow based on the lowest-level public department;
among them, the lowest-level public department is a lowest-level organization department involved in the first processing item.

In some embodiments, the control unit is further configured to send a notification message to the initiator of the first processing item in response to the generation of the processing result of the first processing item after the processing flow of the first processing item is triggered; the details of the processing results can be viewed after the notification message is triggered.

Since the apparatus embodiments basically correspond to the method embodiments, reference can be made to the description of the method embodiments for the relevant points. The apparatus embodiments described above are only schematic, in which the modules described as separate modules may or may not be separate. Some or all of the modules can be selected according to actual needs to achieve the purpose of implementing the technical solution of the embodiments. Those ordinary skilled in the art can understand and implement these without creative labor.

The method and apparatus according to the present disclosure have been described above based on embodiments and application examples. In addition, the present disclosure also provides an electronic device and a computer-readable storage medium, which are described below.

Reference is now made to FIG. 32, which shows a schematic structural diagram of an electronic device (such as a terminal device or a server) 800 suitable for implementing the embodiments of the present disclosure. The terminal device in the embodiment of the present disclosure may include, but not limited to, a mobile terminal such as mobile phone, notebook computer, digital broadcast receiver, PDA (Personal Digital Assistant), PAD (Tablet Computer), PMP (Portable Multimedia Player) and vehicle-mounted terminal (such as vehicle-mounted navigation terminals), and a fixed terminal such as digital TV and desktop computer. The electronic device shown in the figure is only an example, and should not bring any limitation to the function and application scope of the embodiment of the present disclosure.

The electronic device 800 may include a processing device (such as a central processing unit, a graphics processor, etc.) 801, which may perform various appropriate actions and processes according to a program stored in a read-only memory (ROM) 802 or a program loaded from a storage device 808 into a random-access memory (RAM) 803. In the RAM 803, various programs and data required for the operation of the electronic device 800 are also stored. The processing device 801, the ROM 802 and the RAM 803 are connected to each other through a bus 804. An input/output (I/O) interface 805 is also connected to the bus 804.

Generally, the following devices can be connected to the I/O interface 805: an input device 806 including, for example, a touch screen, a touch pad, a keyboard, a mouse, a camera, a microphone, an accelerometer, a gyroscope, etc.; an output device 807 including, for example, a liquid crystal display (LCD), a speaker, a vibrator, etc.; a storage device 808 including, for example, a magnetic tape, a hard disk, etc.; and a communication device 809. The communication device 809 may allow the electronic device 800 to communicate wirelessly or wired with other devices to exchange data. Although the electronic device 800 with various devices is shown in the figure, it should be understood that it is not required to implement or have all the devices shown. More or fewer devices may alternatively be implemented or provided.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program codes for executing the method shown in the flowchart. In such an embodiment, the computer program can be downloaded and installed from the network through the communication device 809, or installed from the storage device 808, or installed from the ROM 802. When the computer program is executed by the processing device 801, the above functions defined in the method of the embodiment of the present disclosure are performed.

It should be noted that the computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or a combination of any of the above. More specific examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, apparatus or device. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program codes contained in the computer-readable medium can be transmitted by any suitable medium, including but not limited to: wires, optical cables, RF (radio frequency) and the like, or any suitable combination of the above.

In some embodiments, the client and the server can communicate by using any currently known or future developed network protocol such as HTTP (HyperText Transfer Protocol), and can be interconnected with digital data communication in any form or medium (for example, communication network). Examples of communication networks include a local area network (“LAN”), a wide area network (“WAN”), the Internet (for example, the Internet) and end-to-end networks (for example, ad hoc end-to-end networks), as well as any currently known or future developed networks.

The above-described computer-readable medium may be included in the electronic device; or it can exist alone without being assembled into the electronic device.

The computer-readable medium carries one or more programs, which, when executed by the electronic device, cause the electronic device to perform the method of the present disclosure.

Computer program codes for performing the operations of the present disclosure may be written in one or more programming languages or combinations thereof, including object-oriented programming languages such as Java, Smalltalk, C++, and conventional procedural programming languages such as “C” or similar programming languages. The program codes can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. Among them, the name of the unit does not constitute the limitation of the unit itself in some cases.

The above functions described in the present disclosure may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or apparatus, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, there is provided an information processing method, including:
in response to a first operation event, displaying an adjustment interface of an organizational structure in a display interface, wherein a pattern of an organization department in the organizational structure is displayed in the adjustment interface, and the pattern is displayed according to a hierarchical relationship of the organization department;
in response to a second operation event based on the pattern, generating a first processing item for adjusting the organizational structure; and
in response to a third operation event, triggering a processing flow of the first processing item.

According to one or more embodiments of the present disclosure, there is provided an information processing method, including:
at least one of the following is satisfied:
displaying, in the adjustment interface, only the pattern of the organization department currently in an activated status;
displaying, in the adjustment interface, only the organization department within a scope of authority of a current user;
displaying, in the adjustment interface, the pattern in a form of a tree structure diagram according to the hierarchical relationship of the organization department;
displaying, in the pattern, a name, a head and a number of department member of a corresponding organization department; and
the adjustment interface is provided with a search control for searching according to the organization department or the head.

According to one or more embodiments of the present disclosure, there is provided an information processing method, including:
when a user opens an adjustment page of the organizational structure for a first time, displaying a guidance interface configured to show an operation mode of the adjustment page of the organizational structure.

According to one or more embodiments of the present disclosure, there is provided an information processing method, including:
in response to the second operation event based on the pattern, generating the first processing item for adjusting the organizational structure, which includes:
in response to a trigger operation on a first control of a first pattern, creating a subordinate department of the organization department corresponding to the first pattern and displaying a pattern of the created subordinate department.

According to one or more embodiments of the present disclosure, there is provided an information processing method, including:
if the organization department corresponding to the first pattern satisfies a first preset condition, displaying the first control; otherwise, the first control is not displayed or cannot be triggered.

According to one or more embodiments of the present disclosure, there is provided an information processing method, including:
the first preset condition includes at least one of the following: the organization department is in an activated status, the organization department has no deactivated version in future, and the organization department is not in a deactivation processing flow.

According to one or more embodiments of the present disclosure, there is provided an information processing method, including:
if the pattern is triggered, displaying an information interface of the organization department corresponding to the triggered pattern, wherein information of the organization department corresponding to the triggered pattern is displayed in the information interface.

According to one or more embodiments of the present disclosure, there is provided an information processing method, including:
at least one of the following is displayed in the information interface:
basic information of the organization department, department members of the organization department, and subordinate departments of the organization department.

According to one or more embodiments of the present disclosure, there is provided an information processing method, including:
at least one of the following is satisfied:
a second control is displayed in the information interface, and the second control is configured to edit the basic information after being triggered;
a third control associated with a department member is displayed in the information interface, and the third control is configured to perform personnel change processing on the associated department member;
among the department members displayed in the information interface, the department member in a personnel change status is preferentially displayed;
among the subordinate departments displayed in the information interface, the subordinate department adjusted in the first processing item is preferentially displayed;
a fourth control associated with the subordinate department is displayed in the information interface, and the fourth control is configured to edit the associated subordinate department after being triggered;
if at least two subordinate departments displayed in the information interface are selected, displaying a fifth control configured to edit the selected subordinate departments in batch after being triggered.

According to one or more embodiments of the present disclosure, there is provided an information processing method, including:
at least one of the following is satisfied:
if the subordinate department displayed in the information interface satisfies a second preset condition, displaying the second control; otherwise, the second control is not displayed or cannot be triggered;
if the selected subordinate department satisfies the second preset condition, displaying the fifth control; otherwise, the fifth control is not displayed or cannot be triggered.

According to one or more embodiments of the present disclosure, there is provided an information processing method, including:
the second preset condition includes at least one of the following: the subordinate department is in an activated status, the subordinate department is not in a deactivation processing item, and the subordinate department is not in a change processing item.

According to one or more embodiments of the present disclosure, there is provided an information processing method, including:
in response to the second operation event based on the pattern, generating the first processing item for adjusting the organizational structure, which includes:
in response to dragging a first pattern to be under a second pattern, adjusting the organization department corresponding to the first pattern as a subordinate department of the organization department corresponding to the second pattern.

According to one or more embodiments of the present disclosure, there is provided an information processing method, including:
at least one of the following is satisfied; otherwise, the dragging of the first pattern fails, or the dragging of the first pattern fails and a corresponding first prompt information is displayed;
the organization department corresponding to the first pattern is in an activated status, the organization department corresponding to the first pattern is not a root node organization department, the organization department corresponding to the first pattern is not in a change processing flow, the organization department corresponding to the first pattern is not in a deactivation processing flow,
the organization department corresponding to the second pattern is in an activated status, the organization department corresponding to the second pattern is not a direct superior department of the organization department corresponding to the first pattern, the organization department corresponding to the second pattern is not the subordinate department of the organization department corresponding to the first pattern, and
a current user has a first authority with respect to the organization department corresponding to the second pattern.

According to one or more embodiments of the present disclosure, there is provided an information processing method, including:
after adjusting the organization department corresponding to the first pattern as the subordinate department of the organization department corresponding to the second pattern,
displaying a first mark in an associated area of the first pattern, wherein the first mark is configured to identify that the organization department corresponding to the first pattern has changed.

According to one or more embodiments of the present disclosure, there is provided an information processing method, including:
in response to the second operation event based on the pattern, generating the first processing item for adjusting the organizational structure, which includes:
in response to dragging a subordinate department displayed in an information interface to be under a third pattern, adjusting the dragged subordinate department as the subordinate department of the organization department corresponding to the third pattern.

According to one or more embodiments of the present disclosure, there is provided an information processing method, including:
at least one of the following is satisfied; otherwise, the dragging of the subordinate department fails, or the dragging of the subordinate department fails and a corresponding second prompt information is displayed;
the dragged subordinate department is in an activated status, the dragged subordinate department is not in a deactivation processing flow, the dragged subordinate department is not in a change processing flow;
the organization department corresponding to the third pattern is in an activated status, the organization department corresponding to the third pattern is not a direct superior department of the dragged subordinate department, the organization department corresponding to the third pattern is not a subordinate department of the dragged subordinate department.

According to one or more embodiments of the present disclosure, there is provided an information processing method, including:
after dragging the subordinate department to be under the organization department corresponding to the third pattern, determining whether the organization department corresponding to the third pattern satisfies a third preset condition; and if the organization department corresponding to the third pattern does not satisfy the third preset condition, sending a third prompt information;
the third preset condition includes at least one of the following: the organization department corresponding to the third pattern is not in a deactivation processing flow, and the organization department corresponding to the third pattern has no deactivated version in future.

According to one or more embodiments of the present disclosure, there is provided an information processing method, including:
displaying at least one of the following in the pattern or in an associated area of the pattern: a sixth control configured to activate an organization department, a seventh control configured to disactivate an organization department, and an eighth control configured to delete an organization department.

According to one or more embodiments of the present disclosure, there is provided an information processing method, including:
at least one of the following is satisfied:
if the organization department corresponding to the pattern is in a deactivated status, displaying the sixth control; otherwise, the sixth control is not displayed;
if the organization department corresponding to the pattern satisfies a fourth preset condition, displaying the seventh control; otherwise, the seventh control is not displayed or the seventh control is unavailable, wherein the fourth preset condition includes at least one of the following: the organization department is in an activated status, the organization department is not in a deactivation processing flow, the organization department is not in a change processing flow, the organization department has no activated version in future, the organization department has no subordinate department activated currently and activated in future, the organization department has no current employee and future employee, the organization department has no department member in a personnel change status;
if the organization department corresponding to the pattern satisfies a fifth preset condition, displaying the eighth control; otherwise, the eighth control is not displayed or the eighth control is unavailable, wherein the eighth control includes at least one of the following: the organization department is newly created in the first processing item, the organization department has no subordinate department, the organization department has no department member in a personnel change status.

According to one or more embodiments of the present disclosure, there is provided an information processing method, including:
at least one of the following is satisfied:
saving the first processing item for adjusting the organizational structure in real time or at fixed time;
if an adjustment of the organizational structure is exited before a user saves the first processing item, displaying a saving interface configured to save the first processing item;
if the adjustment of the organizational structure is exited after the user saves the first processing item, displaying a fourth prompt information;
if the adjustment of the organizational structure is entered again after the adjustment interface of the organizational structure is abnormally exited, displaying a continuous processing interface configured to determine whether to continue to execute the first processing item.

According to one or more embodiments of the present disclosure, there is provided an information processing method, including:
after triggering the pattern, displaying an information interface of the corresponding organization department, wherein a department member is displayed in the information interface of the organization department, and at least one of the following is satisfied:
the department member has an associated third control configured to perform personnel change processing on the associated department member;
the department member has an associated ninth control configured to select the associated department member; and after the ninth control is selected, displaying a tenth control configured to perform personnel change processing on the selected department member associated with the ninth control;
if the department member is dragged to be under a displayed pattern, performing personnel change processing on the dragged department member according to the organization department associated with the target pattern.

According to one or more embodiments of the present disclosure, there is provided an information processing method, including:
at least one of the following is satisfied:
if the department member satisfies a sixth preset condition, displaying the associated third control; otherwise, hiding the third control or the third control being unavailable;
if the department member satisfies the sixth preset condition, displaying the associated ninth control; otherwise, hiding the ninth control or the ninth control being unavailable;
after triggering the tenth control, if the selected ninth control does not satisfy the sixth preset condition, displaying a fifth prompt information without performing personnel change processing; and
if the organization department associated with the target pattern does not satisfy a seventh preset condition, displaying a sixth prompt information without performing personnel change processing.

According to one or more embodiments of the present disclosure, there is provided an information processing method, including:
the sixth preset condition includes at least one of the following: the department member has no personnel change processing item, the department member has no resignation processing item, and the department member has no ineffective employment item;
the seventh preset condition includes at least one of the following: the organization department associated with the target pattern is in an activated status, the organization department associated with the target pattern is not the organization department to which the dragged department member currently belongs, the organization department associated with the target pattern has no deactivated version in future, and the organization department associated with the target pattern has no deactivation processing item.

According to one or more embodiments of the present disclosure, there is provided an information processing method, including:
after generating the first processing item for adjusting the organizational structure and before being in response to the third operation event, the method further includes:
in response to a trigger operation on an eleventh control, displaying an adjustment record page, wherein an adjustment content carried out in the first processing item is displayed in the adjustment record page.

According to one or more embodiments of the present disclosure, there is provided an information processing method, including:
the adjustment content carried out in the first processing item and displayed in the adjustment record page includes at least one of the following: an adjustment record of the organization department and a personnel change record of the department member;
the adjustment record of the organization department includes at least one of the following: adjustment type, department name, superior department, head, code number, department description, confidentiality status, edition control and removal control;
the personnel change record of the department member includes at least one of the following: name, information before personnel change, information after personnel change, edition control and removal control.

According to one or more embodiments of the present disclosure, there is provided an information processing method, including:
at least one of the following is satisfied:
if the organization department corresponding to the adjustment record satisfies an eighth preset condition, the removal control in the adjustment record of the organization department is unavailable; the eighth preset condition includes: the organization department is a newly-created organization department and has a subordinate department; the organization department is a newly-created organization department and has a department member transferred thereto through personnel change; the superior department of the organization department before adjustment has been deactivated; the hierarchical relationship of the organization department forms a closed loop after the adjustment record is removed;
if the organization department, to which the department member corresponding to the personnel change record originally belongs, is deactivated in the first processing item, the removal control in the personnel change record is unavailable.

According to one or more embodiments of the present disclosure, there is provided an information processing method, including:
in response to the third operation event, triggering the processing flow of the first processing item, which includes:
in response to a trigger operation on an eleventh control, displaying a submission interface; and in response to a confirmation operation on the submission interface, triggering the processing flow of the first processing item, wherein
at least one of the following is displayed in the submission interface: subject name, effective time and adjustment reason.

According to one or more embodiments of the present disclosure, there is provided an information processing method, including:
after triggering the processing flow of the first processing item, if there is a conflicting adjustment content in the first processing item, displaying a conflict information interface, and displaying the conflicting adjustment content in the conflict information interface.

According to one or more embodiments of the present disclosure, there is provided an information processing method, including:
a control configured to remove all conflicting adjustment contents is displayed in the conflict information interface; and
the adjustment content displayed in the conflict information interface has at least one of the following: an associated control configured to edit the adjustment content and an associated control configured to remove the adjustment content.

According to one or more embodiments of the present disclosure, there is provided an information processing method, including:
after triggering the processing flow of the first processing item, the method further includes: in response to a trigger operation on a twelfth control, displaying a processing item interface, wherein a processing item record initiated by a current user is displayed in the processing item interface.

According to one or more embodiments of the present disclosure, there is provided an information processing method, including:
at least one of the following is satisfied:
depending on a current status, a processing item displayed in the processing item interface includes at least one of the following: a control configured to view the processing item, a control configured to edit the processing item and a control configured to delete the processing item;
if there is a conflicting adjustment content in the processing item displayed in the processing item interface, displaying a prompt identifier.

According to one or more embodiments of the present disclosure, there is provided an information processing method, including:
after triggering a control displayed in the processing item interface and configured to view a processing item, displaying a processing item status interface;
at least one of the following is displayed in the processing item status interface:
summary information of a processing item, a control configured to withdraw a processing item, a control configured to view the processing flow, a control configured to view a processing result of each node of the processing flow, an adjustment record in the processing item, a control configured to edit the adjustment record, and a control configured to remove the adjustment record.

According to one or more embodiments of the present disclosure, there is provided an information processing method, including:
triggering the processing flow of the first processing item, which includes:
determining a lowest-level public department involved in the first processing item, and configuring the processing flow based on the lowest-level public department; wherein
the lowest-level public department is a lowest-level organization department involved in the first processing item.

According to one or more embodiments of the present disclosure, there is provided an information processing method, including:
after triggering the processing flow of the first processing item, the method further includes:
in response to a generation of a processing result of the first processing item, sending a notification message to an initiator of the first processing item, wherein the notification message is configured for viewing a detail of the processing result after being triggered.

According to one or more embodiments of the present disclosure, there is provided an information processing apparatus, including:
a display unit, configured to display an adjustment interface of an organizational structure in a display interface in response to a first operation event, wherein a pattern of an organization department in the organizational structure is displayed in the adjustment interface, and the pattern is displayed according to a hierarchical relationship of the organization department;
a control unit, configured to generate a first processing item for adjusting the organizational structure in response to a second operation event based on the pattern; and
a processing unit, configured to trigger a processing flow of the first processing item in response to a third operation event.

According to one or more embodiments of the present disclosure, there is provided an electronic device including:
at least one memory and at least one processor; and
the at least one memory is configured to store program codes, and the at least one processor is configured to invoke the program codes stored in the at least one memory to perform the method described in any one of the above.

According to one or more embodiments of the present disclosure, there is provided a computer-readable storage medium for storing program codes which, when executed by a processor, cause the processor to perform the above method.

The above description merely relates to the preferred embodiments of the present disclosure and the explanation of the applied technical principles. It should be understood by those skilled in the art that the disclosure scope involved in the present disclosure is not limited to the technical solutions formed by specific combination of the above technical features, but also covers other technical solutions formed by any combination of the above technical features or their equivalent features without departing from the above disclosure concept. For example, technical solutions formed by replacing the above features with (but not limited to) technical features having similar functions disclosed in the present disclosure.

Furthermore, although the operations are depicted in a particular order, this should not be understood as requiring that these operations be performed in the particular order as shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. Instead, the specific features and actions described above are only exemplary forms of implementing the claims.

1. An information processing method, comprising:
in response to a first operation event, displaying an adjustment interface of an organizational structure in a display interface, wherein a pattern of an organization department in the organizational structure is displayed in the adjustment interface, and the pattern is displayed according to a hierarchical relationship of the organization department;
in response to a second operation event based on the pattern, generating a first processing item for adjusting the organizational structure; and
in response to a third operation event, triggering a processing flow of the first processing item.

2. The method according to claim 1, wherein at least one of the following is satisfied:
displaying, in the adjustment interface, only the pattern of the organization department currently in an activated status;
displaying, in the adjustment interface, only the organization department within a scope of authority of a current user;
displaying, in the adjustment interface, the pattern in a form of a tree structure diagram according to the hierarchical relationship of the organization department;
displaying, in the pattern, a name, a head and a number of department member of a corresponding organization department; and
the adjustment interface is provided with a search control for searching according to the organization department or the head.

3. (canceled)

4. The method according to claim 1, wherein in response to the second operation event based on the pattern, generating the first processing item for adjusting the organizational structure, comprising:
in response to a trigger operation on a first control of a first pattern, creating a subordinate department of the organization department corresponding to the first pattern and displaying a pattern of the created subordinate department.

5. The method according to claim 4, wherein
if the organization department corresponding to the first pattern satisfies a first preset condition, displaying the first control; otherwise, the first control is not displayed or cannot be triggered,
wherein the first preset condition comprises at least one of the following:
the organization department is in an activated status,
the organization department has no deactivated version in future, and
the organization department is not in a deactivation processing flow.

6. (canceled)

7. The method according to claim 1, wherein
if the pattern is triggered, displaying an information interface of the organization department corresponding to the triggered pattern, wherein information of the organization department corresponding to the triggered pattern is displayed in the information interface,
wherein at least one of the following is displayed in the information interface:
basic information of the organization department,
department members of the organization department, and
subordinate departments of the organization department.

8. (canceled)

9. The method according to claim 7, wherein at least one of the following is satisfied:
a second control is displayed in the information interface, and the second control is configured to edit the basic information after being triggered;
a third control associated with a department member is displayed in the information interface, and the third control is configured to perform personnel change processing on the associated department member;
among the department members displayed in the information interface, the department member in a personnel change status is preferentially displayed;
among the subordinate departments displayed in the information interface, the subordinate department adjusted in the first processing item is preferentially displayed;
a fourth control associated with the subordinate department is displayed in the information interface, and the fourth control is configured to edit the associated subordinate department after being triggered;
if at least two subordinate departments displayed in the information interface are selected, displaying a fifth control configured to edit the selected subordinate departments in batch after being triggered.

10. The method according to claim 9, wherein at least one of the following is satisfied:
if the subordinate department displayed in the information interface satisfies a second preset condition, displaying the second control; otherwise, the second control is not displayed or cannot be triggered;
if the selected subordinate department satisfies the second preset condition, displaying the fifth control; otherwise, the fifth control is not displayed or cannot be triggered,
wherein the second preset condition comprises at least one of the following:
the subordinate department is in an activated status,
the subordinate department is not in a deactivation processing item, and
the subordinate department is not in a change processing item.

11. (canceled)

12. The method according to claim 1, wherein in response to the second operation event based on the pattern, generating the first processing item for adjusting the organizational structure, comprising:
in response to dragging a first pattern to be under a second pattern, adjusting the organization department corresponding to the first pattern as a subordinate department of the organization department corresponding to the second pattern.

13. The method according to claim 12, wherein at least one of the following is satisfied; otherwise, the dragging of the first pattern fails, or the dragging of the first pattern fails and a corresponding first prompt information is displayed,
the organization department corresponding to the first pattern is in an activated status, the organization department corresponding to the first pattern is not a root node organization department, the organization department corresponding to the first pattern is not in a change processing flow, the organization department corresponding to the first pattern is not in a deactivation processing flow,
the organization department corresponding to the second pattern is in an activated status, the organization department corresponding to the second pattern is not a direct superior department of the organization department corresponding to the first pattern, the organization department corresponding to the second pattern is not the subordinate department of the organization department corresponding to the first pattern, and
a current user has a first authority with respect to the organization department corresponding to the second pattern.

14. The method according to claim 12, wherein after adjusting the organization department corresponding to the first pattern as the subordinate department of the organization department corresponding to the second pattern,
displaying a first mark in an associated area of the first pattern, wherein the first mark is configured to identify that the organization department corresponding to the first pattern has changed.

15. The method according to claim 1, wherein in response to the second operation event based on the pattern, generating the first processing item for adjusting the organizational structure, comprising:
in response to dragging a subordinate department displayed in an information interface to be under a third pattern, adjusting the dragged subordinate department as the subordinate department of the organization department corresponding to the third pattern,
wherein at least one of the following is satisfied; otherwise, the dragging of the subordinate department fails, or the dragging of the subordinate department fails and a corresponding second prompt information is displayed,
the dragged subordinate department is in an activated status, the dragged subordinate department is not in a deactivation processing flow, the dragged subordinate department is not in a change processing flow;
the organization department corresponding to the third pattern is in an activated status, the organization department corresponding to the third pattern is not a direct superior department of the dragged subordinate department, the organization department corresponding to the third pattern is not a subordinate department of the dragged subordinate department.

16. (canceled)

17. The method according to claim 15, wherein,
after dragging the subordinate department to be under the organization department corresponding to the third pattern, determining whether the organization department corresponding to the third pattern satisfies a third preset condition; and if the organization department corresponding to the third pattern does not satisfy the third preset condition, sending a third prompt information;
the third preset condition comprises at least one of the following: the organization department corresponding to the third pattern is not in a deactivation processing flow, and the organization department corresponding to the third pattern has no deactivated version in future.

18. The method according to claim 1, wherein displaying at least one of the following in the pattern or in an associated area of the pattern:
a sixth control configured to activate an organization department,
a seventh control configured to disactivate an organization department, and
an eighth control configured to delete an organization department,
wherein at least one of the following is satisfied:
if the organization department corresponding to the pattern is in a deactivated status, displaying the sixth control; otherwise, the sixth control is not displayed;
if the organization department corresponding to the pattern satisfies a fourth preset condition, displaying the seventh control; otherwise, the seventh control is not displayed or the seventh control is unavailable, wherein the fourth preset condition comprises at least one of the following: the organization department is in an activated status, the organization department is not in a deactivation processing flow, the organization department is not in a change processing flow, the organization department has no activated version in future, the organization department has no subordinate department activated currently and activated in future, the organization department has no current employee and future employee, the organization department has no department member in a personnel change status;
if the organization department corresponding to the pattern satisfies a fifth preset condition, displaying the eighth control; otherwise, the eighth control is not displayed or the eighth control is unavailable, wherein the eighth control comprises at least one of the following: the organization department is newly created in the first processing item, the organization department has no subordinate department, the organization department has no department member in a personnel change status.

19. (canceled)

20. The method according to claim 1, wherein at least one of the following is satisfied:
saving the first processing item for adjusting the organizational structure in real time or at fixed time;
if an adjustment of the organizational structure is exited before a user saves the first processing item, displaying a saving interface configured to save the first processing item;
if the adjustment of the organizational structure is exited after the user saves the first processing item, displaying a fourth prompt information;
if the adjustment of the organizational structure is entered again after the adjustment interface of the organizational structure is abnormally exited, displaying a continuous processing interface configured to determine whether to continue to execute the first processing item.

21. The method according to claim 1, wherein after triggering the pattern, displaying an information interface of the corresponding organization department, wherein a department member is displayed in the information interface of the organization department, and at least one of the following is satisfied:
the department member has an associated third control configured to perform personnel change processing on the associated department member;
the department member has an associated ninth control configured to select the associated department member; and after the ninth control is selected, displaying a tenth control configured to perform personnel change processing on the selected department member associated with the ninth control;
if the department member is dragged to be under a target pattern as displayed, performing personnel change processing on the dragged department member according to the organization department associated with the target pattern.

22. The method according to claim 21, wherein at least one of the following is satisfied:
if the department member satisfies a sixth preset condition, displaying the associated third control; otherwise, hiding the third control or the third control being unavailable;
if the department member satisfies the sixth preset condition, displaying the associated ninth control; otherwise, hiding the ninth control or the ninth control being unavailable;
after triggering the tenth control, if the selected ninth control does not satisfy the sixth preset condition, displaying a fifth prompt information without performing personnel change processing; and
if the organization department associated with the target pattern does not satisfy a seventh preset condition, displaying a sixth prompt information without performing personnel change processing.

23. The method according to claim 22, wherein
the sixth preset condition comprises at least one of the following: the department member has no personnel change processing item, the department member has no resignation processing item, and the department member has no ineffective employment item;
the seventh preset condition comprises at least one of the following: the organization department associated with the target pattern is in an activated status, the organization department associated with the target pattern is not the organization department to which the dragged department member currently belongs, the organization department associated with the target pattern has no deactivated version in future, and the organization department associated with the target pattern has no deactivation processing item.

24-33. (canceled)

34. The method according to claim 1, wherein after triggering the processing flow of the first processing item, the method further comprises:
in response to a generation of a processing result of the first processing item, sending a notification message to an initiator of the first processing item, wherein the notification message is configured for viewing a detail of the processing result after being triggered.

35. An information processing apparatus, comprising:
a display unit, configured to display an adjustment interface of an organizational structure in a display interface in response to a first operation event, wherein a pattern of an organization department in the organizational structure is displayed in the adjustment interface, and the pattern is displayed according to a hierarchical relationship of the organization department;
a control unit, configured to generate a first processing item for adjusting the organizational structure in response to a second operation event based on the pattern; and
a processing unit, configured to trigger a processing flow of the first processing item in response to a third operation event.

36. An electronic device, comprising:
at least one memory and at least one processor;
wherein the at least one memory is configured to store program codes, and the at least one processor is configured to invoke the program codes stored in the at least one memory to perform the method according to claim 1.

37. (canceled)
